(19) United States
(12) Patent Application Publication
(10) Pub. No.: US 2026/0331918 A1
(43) Pub. Date: Oct. 22, 2026

(54) SYTEMS AND METHODS FOR PROVIDING BULK POWER GRID RESILIENCE

(71) Applicant: Volta Energy Inc., Toronto (CA)

(72) Inventors: Takis Constantine Zourntos, Toronto (CA); Shichen Fan, Toronto (CA); Siddharth Swaminathan, Scarborough (CA); Gursaran Singh, Toronto (CA)

(21) Appl. No.: 19/644,557

(22) Filed: Apr. 10, 2026

Related U.S. Application Data
(60) Provisional application No. 63/790,262, filed on Apr. 17, 2025.

(51) Int. Cl. H02J 3/32; H02J 3/0012; H02J 3/38; H02J 15/50; H02J 101/30; H02J 103/30

(52) U.S. Cl. CPC H02J 3/32; H02J 3/0012; H02J 3/381; H02J 15/50; H02J 2101/30; H02J 2103/30

(57) ABSTRACT

Existing power grid systems power systems may not include solutions for maximizing fuel cell longevity and boosting short-term fuel cell capacity. To address at least these problems, in some examples, a method includes receiving an input condition, wherein the input condition includes an energy buffering mode or an energy storage mode. The method may also include configuring, in response to the input condition including the energy buffering mode, a fuel cell stack and a rapid discharge electric storage system to operate in the energy buffering mode. The method may also include configuring, in response to the input condition including the energy storage mode, the fuel cell stack and the rapid discharge electric storage system to operate in the energy storage mode.

### CROSS-REFERENCE TO RELATED PATENT APPLICATIONS

This application claims the benefit of and priority from United States provisional patent application no. U.S. 63/790,262, filed Apr. 17, 2025, the entire contents of which are incorporated herein by reference.

### FIELD

The present application relates to electric power infrastructure, and in particular to managing a microgrid.

### BACKGROUND

The increasing prevalence of large intermittent loads such as electric vehicle charging stations and industrial electrified manufacturing processes, presents a significant challenge to existing electric power infrastructure. While bulk generation, including hydro-electric, nuclear and fossil fuel sources can provide most of the regional electrical energy supply, rapid-response power generators are needed to accommodate power spikes from intermittent loads, particularly in times of peak demand. There is also a need to ensure grid resiliency and to offset the transient effects of intermittent loads, such as to improve power quality.

### SUMMARY

An electrical power grid may include two major parts: a bulk power grid and a distribution grid. The bulk power grid may include significant sources of energy, such as regional hydroelectric and nuclear stations and long-distance high-voltage power transmission equipment. The distribution grid may include substations and lower voltage equipment, including local residential and industrial electrical services.

Conventionally, power may flow unidirectionally from the bulk generators through a network of long-distance transmission lines to the distribution grid and industrial or residential loads. However, the anticipated “modern power grid” may also feature much more distribution-side generation. Moreover, the current worldwide need to reduce carbon dioxide emissions and reliance on fossil fuels, has resulted in a greater electrification of loads. Certain loads in industrial and residential settings can create massive and intermittent power demand for which the power grid was not originally designed, leading to power quality issues and potentially even catastrophic failure of the power grid.

The distributed generator (DG) is becoming more widespread (and is often based on renewable but highly variable sources of energy, such as wind or solar energy), as is the establishment of so-called “microgrids” which can operate autonomously, for a period of time, from the bulk power grid. These DGs, which may be incorporated in an ad hoc manner, are dynamic elements that may adversely affect grid reliability. Distributed storage (DS) is also becoming more prevalent, particularly in microgrids which may “island” from the bulk power system for lengths of time. Storage may also be incorporated typically in an ad hoc manner.

Moreover, the problem of overall system stability, given a high penetration of DGs and microgrids, is still open. The future of the electric power grid is expected to be unpredictable and much more complicated than in the recent past.

Existing power systems may lack a systematic approach for the incorporation of DG and DS elements, which could help to ensure overall power system stability. These systems may also need to contend with intermittent high-power loads (i.e., the need for a rapid response DG/DS technology).

These power systems may also not include solutions for maximizing fuel cell longevity and boosting short-term fuel cell capacity. As will be discussed in more detail below, short-term fuel cell capacity may be boosted by supplementing fuel cell operation with a rapid discharge electric storage system technology (e.g., supercapacitors), which can provide brief bursts of power and allow for the ride-through of intermittent faults. It may also be advantageous for these power systems to smoothly transition between operation of the rapid discharge electric storage system and the fuel cell(s).

Existing power systems may also need to support the proliferation and integration of intermittent renewable energy sources. In addition, these existing power systems may need increased reliability, failure-mode detection and cyber-security verification technology, which may not be present in existing power system design.

Although power system stability is a well-established area in the industry, existing solutions for fuel cell system controls and power regulation are strictly “local” in nature and do not consider the dynamics of the external power grid. These approaches use several types of controls, from model reference to fuzzy-logic controls. Power system stability is an ongoing area of study and development, since the nature of the power system is continually changing. Other solutions exist for the control of electric power generators and associated machinery.

However, existing solutions have not yet identified a set of microgrid elements which may help ensure overall grid reliability. For example, existing solutions have not identified the particular combination of a fuel cell and a rapid discharge electric storage system (e.g. a supercapacitor or supercapacitor bank) to help ensure overall grid reliability. This combination may also be included in the microgrid along with fuel storage and renewable generation. The solutions described herein may account for actual system dynamics (state-space models) corresponding to the bulk power grid, fuel cells, and other components. Other solutions consider the microgrid in isolation, rather than as part of larger power infrastructure. The solutions discussed herein may create a microgrid that “plays well” with the greater power grid while also providing necessary local electrical service.

For example, one solution to the problems discussed above is to boost short-term fuel cell capacity by supplementing fuel cell operation with a rapid discharge electric storage system technology, which can provide brief bursts of power and allow for the ride-through of intermittent faults. It may also be advantageous for these power systems to smoothly transition between operation of the rapid discharge electric storage system and the fuel cell(s).

As well, reliability, failure-mode detection and cyber-security verification may be improved with the incorporation of one or more “digital twins,” such as software models which model the local bulk power grid, microgrid and/or other components. These digital twins may provide approximations and/or predictions of electrical, thermal, demand and other characteristics of the modelled systems.

In one solution, there is provided a microgrid architecture, which may include a fuel cell stack, a rapid discharge electric storage system. In some implementations, the rapid discharge electric storage system may be a bank of supercapacitors. The fuel cell stack may also be reversible. As well, the control elements may include one or more controllers, switches, control systems and/or digital twins. The microgrid architecture may be coupled or connected to a local bulk power grid.

The microgrid architecture may also include necessary energy storage, power electronics, control and provisioning for attaching loads (for example, residential or commercial loads), as well as distributed generation. Although loads and DGs may be incorporated into microgrids in general, these may not be necessary for the present microgrid architecture. In this context, the fuel cell stack may not be considered to be a DG.

The microgrid architecture may make use of fuel cell and supercapacitor technology, which may provide the basis for rapid response by the microgrid. The architecture may also provide a requisite controlled (closed-loop) operation to ensure stability and tracking performance of all components.

The microgrid architecture may also consider the overall dynamics of the power grid system, including the dynamics of a local portion of the bulk power grid to which the microgrid architecture is coupled. This may allow the microgrid architecture to provide theoretical stability within a certain tolerance and improved transient performance. The behaviour of the microgrid architecture may be predictable, and the limits on performance and tolerance to parametric uncertainty may be determinable.

The microgrid architecture may also include a set of algorithms for verification of signaling by using redundant or diverse measurements to ensure signal integrity and correct system operation. These functions may allow greater reliability, traceability of anomalies and increased cyber-security. A software-based digital twin apparatus may be included to double check system measurements and states for additional fault detection and identification. At a high-level, an AI sub-system may also be used recognize and detect fault signatures in raw data and calculations or approximations generated by the digital twin and control systems.

In one aspect, there is provided a method. The method may include receiving an input condition, wherein the input condition includes an energy buffering mode or an energy storage mode. The method may also include configuring, in response to the input condition including the energy buffering mode, a fuel cell stack and a rapid discharge electric storage system to operate in the energy buffering mode. The energy buffering mode may include coupling, for a first time period, the rapid discharge electric storage system to the local bulk power grid, wherein the rapid discharge electric storage system provides a rapid discharge of power to the local bulk power grid. The energy buffering mode may also include coupling, for a second time period, the fuel cell stack to the local bulk power grid, wherein the fuel cell stack operates in a fuel cell mode and provides a steady discharge of power to the local bulk power grid. The method may also include configuring, in response to the input condition including the energy storage mode, the fuel cell stack and the rapid discharge electric storage system to operate in the energy storage mode. The energy storage mode may include charging the rapid discharge electric storage system with excess power from the local bulk power grid. The energy storage mode may also include configuring the fuel cell stack to operate in an electrolyzer mode. The energy storage mode may further include generating, using the fuel cell stack, fuel from the excess power.

In some implementations, the energy buffering mode may further include configuring, in the first time period, the fuel cell stack to build current density before discharging power to the local bulk power grid.

In some implementations, the input condition may be based on a prediction generated by a digital twin modelling the local bulk power grid, the prediction including at least one of duress or excess power in the local bulk power grid.

In some implementations, the digital twin may further model the rapid discharge electric storage system and the fuel cell stack.

In some implementations, the digital twin may include at least one of nonlinear ordinary differential equations (ODEs), machine learning models or deep learning models.

In some implementations, the fuel cell stack may include at least one of a Reversible Solid Oxide Cell (ReSOC) or a Proton Exchange Membrane (PEM) fuel cell.

In some implementations, the fuel generated in the electrolyzer mode by the fuel cell stack may be hydrogen or hydrogen-based.

In some implementations, configuring the fuel cell stack and the rapid discharge electric storage system may include a controller setting operating conditions of the fuel cell stack and the rapid discharge electric storage system based on the input condition and monitoring performance of the fuel cell stack and the rapid discharge electric storage system in a closed loop.

In some implementations, the method may further include receiving the input condition from a computing device associated with an energy operator.

In some implementations, the method may further include detecting, using an artificial intelligence (AI) model, a fault signature in at least one of a measurement or prediction corresponding to the local bulk power grid; and configuring, using the controller, the operating conditions of the fuel cell stack and the rapid discharge electric storage system based on the detected fault signature.

In some implementations, the rapid discharge electric storage system may include at least one supercapacitor.

In another aspect, there is provided a system. The system may include a fuel cell stack, wherein the fuel cell is operable in a fuel cell mode and an electrolyzer mode. They system may also include a rapid discharge electric storage system. The system may also include a controller coupled to the fuel cell and the supercapacitor. The controller may be configured to receive an input condition. The controller may also be configured to configure, in response to the input condition corresponding to an energy buffering mode for a local bulk power grid, the rapid discharge electric storage system to discharge to provide power to the local bulk power grid in a first time period and the fuel cell stack to operate in the fuel cell mode to provide power to the local bulk power grid in a second time period. The controller may also be configured to configure, in response to the input condition corresponding to an energy storage mode, the fuel cell stack to perform an electrolyzer function to generate fuel and the rapid discharge electric storage system to charge.

In some implementations, in response to the input condition corresponding to an energy buffering mode, the controller may be further configured to configure the fuel cell stack, in the first time period, to build current density before providing power to the local bulk power grid.

In some implementations, the input condition may be based on a prediction generated by a digital twin modelling the local bulk power grid, the prediction including at least one of duress or excess power in the local bulk power grid.

In some implementations, the digital twin may further model the rapid discharge electric storage system and the fuel cell stack.

In some implementations, the digital twin may include at least one of nonlinear ordinary differential equations (ODEs), machine learning models or deep learning models.

In some implementations, the fuel cell stack may include at least one of a Reversible Solid Oxide Cell (ReSOC) or a Proton Exchange Membrane (PEM) fuel cell.

In some implementations, the fuel generated by the fuel cell stack may be hydrogen or hydrogen-based.

In some implementations, configuring the fuel cell stack and the rapid discharge electric storage system may include a controller setting operating conditions of the fuel cell stack and the rapid discharge electric storage system based on the input condition and monitoring performance of the fuel cell stack and the rapid discharge electric storage system in a closed loop.

In some implementations, the controller may be further configured to receive the input condition from a computing device associated with an energy operator.

In some implementations, the controller may be further configured to receive, from an artificial intelligence (AI) model, a detection of a fault signature in at least one of a measurement or prediction corresponding to the local bulk power grid; and configure operating conditions of the fuel cell stack and the rapid discharge electric storage system based on the detected fault signature.

In another aspect, there is provided a system. The system may include a direct current (DC) bus. The system may also include a fuel cell stack connected to the DC bus through a first switch, wherein the fuel cell stack is operable in a fuel cell mode for power generation and an electrolyzer mode for fuel storage. The system may also include a supercapacitor bank connected to the DC bus through a second switch. The system may also include a third switch coupling the DC bus to a bulk power grid connector. The system may further include a controller in communication with the first switch, the second switch, the third switch and the fuel cell stack. The controller may be configured to open and close at least one of the first switch, the second switch or the third switch. The controller may also be configured to toggle the fuel cell stack between the fuel cell mode and the electrolyzer mode.

In some implementations, the system may further include one or more transformers coupled to the bulk power grid connector.

In some implementations, the system may further include a power converter for converting DC power from the DC bus to three-phase alternating current (AC) power for input to the third switch.

In some implementations, the controller may be further configured to set operating conditions of the fuel cell stack and the supercapacitor bank based on at least one of input received from a computing device associated with an energy operator or a prediction generated by a digital twin modelling a local bulk power grid coupled to the bulk power grid connected; and monitor performance of the fuel cell stack and the supercapacitor bank in a closed loop.

In some implementations, the prediction generated by the digital twin may correspond to a prediction of duress or excess power in the local bulk power grid.

In some implementations, the fuel cell stack may include at least one fuel cell and at least one electrolyzer.

### BRIEF DESCRIPTION OF DRAWINGS

Embodiments will be described, by way of example only, with reference to the accompanying figures:

FIG. 1 is a block diagram of a microgrid system, according to some implementations;

FIG. 2 is a block diagram of a microgrid manager in the microgrid system of FIG. 1;

FIG. 3 is a block diagram of a microgrid in the microgrid system of FIG. 1;

FIG. 4 is a block diagram of a fuel cell stack in the microgrid of FIG. 3;

FIG. 5 is a block diagram of a rapid discharge electric storage system in the microgrid of FIG. 3;

FIG. 6 is a block diagram of a digital twin in the microgrid manager of FIG. 2;

FIG. 7 is a block diagram of control systems in the microgrid manager of FIG. 2;

FIG. 8 is a timing diagram of an energy buffering mode, according to some implementations;

FIG. 9 is a timing diagram of an energy storage mode, according to some implementations;

FIGS. 10-12 are example methods for performing the energy buffering mode and energy storage mode of FIGS. 8 and 9, according to some implementations;

FIG. 13 is a block diagram of another microgrid system, according to some implementations;

FIG. 14 is a flow diagram illustrating an example operation of the microgrid system of FIG. 13;

FIG. 15 is a schematic diagram of an example fuel cell stack in the microgrid system of FIG. 13;

FIG. 16 is a schematic diagram of a model of a fuel cell stack in a fuel cell mode;

FIG. 17 is a schematic diagram of a model of a fuel cell stack in an electrolysis or electroylzer mode;

FIG. 18 is a block diagram for a control system incorporating the model of FIG. 16;

FIG. 19 is a block diagram of a microgrid in the microgrid system of FIG. 13; and

FIGS. 20-21 are graphs depicting power plots for an example microgrid system.

### DETAILED DESCRIPTION

In some implementations, a microgrid system includes a reversible fuel cell, a rapid discharge electric storage system, and suitable controls and models. The rapid discharge electric storage system may be or include a supercapacitor bank. In addition, the models may include mathematical models of the microgrid's own components, as well as a model of the local bulk power grid. The system may also include a controllable power converter and switches. The switches may be used to ensure that elements are controllably coupled or connected to one another.

As used herein, the term “coupled” means that two components may transfer electrical energy, either from component to the other or from each component to the other. Two components may be coupled without being directly connected. For example, the components may be separated by a transformer, capacitor, inductor, diode or other component which prevents the components from being directly connected. Two coupled components may share electrical, magnetic, kinetic, potential or other forms of energy. It will be appreciated that the two components may be “decoupled” if, for example, a switch interposed between the two components is opened, such that the components are unable to transfer electrical energy.

As well, the term “connected” as used herein means that two components are in direct contact, such that a terminal of one component is in contact with a terminal of another components, or the terminals are in contact through some interstitial component, such as a wire contacting the two terminals. However, connected may also mean that a resistor, capacitor, inductor or some other component may be interposed between the two components. Connected may also mean that an electrical circuit exists between the two components, such that current flows between the two components. A connection may include two components which are in communication with one another, such as over a digital bus or data bus. A connection may also include two components which transfer electrical energy to one another over a common power bus. It will be appreciated that the two components may be “disconnected” if, for example, a switch interposed between the two components is opened.

Distributed generation, transformers and the local bulk power grid, may not be included in the microgrid system, but may provide context for the system.

Some sort of electrical power generation from renewable sources, such as wind turbines or solar arrays, may also complement or interact with the system. A generator may also be included in the model for the local bulk power system. Similarly, loads, as well as certain portions of the greater power grid, may also be considered as part of the local bulk power system.

A set of nonlinear ordinary differential equations (ODEs) may also be available, which may be used to model the operation of the local bulk power system. This model may be used for the synthesis of suitable controls. The model may be derived using nonlinear controls and power systems theory. The system may also incorporate this explicit mathematical model for the local bulk power system.

In another particular embodiment, a method includes configuring the fuel cell stack and the rapid discharge electric storage system depending on an input condition. The fuel cell stack and the rapid discharge electric storage system may be configured in an energy buffering mode or an energy storage mode. The input condition may include a grid command from an energy operator or a prediction from one or more models, such as a digital twin. The prediction may include a prediction of duress or excess power in the local bulk power grid.

The method may also involve various controllers operated in a coordinated manner. When an imminent fault, distinct event or request from a power system operator is detected or received, the controllers may “pre-tune” or select a set of parameters to allow the system to respond in an optimal manner.

In a high-demand scenario, where the local bulk power grid is under duress (as indicated by changes in voltage frequency, amplitude or phase), a fuel-cell mode may be autonomously engaged for the fuel cell stack. The rapid discharge electric storage system (e.g. a supercapacitor bank) may also be engaged. The fuel cell stack and rapid discharge electric storage system may be engaged using suitable control algorithms and configured to provide energy buffering to the grid. The various components may operate to provide extra power to the local bulk power grid as needed by loads or system operator requests.

In some implementations, the coordination of the rapid discharge electric storage system and fuel cell stacks may be smooth and seamless. For example, where the rapid discharge electric storage system (e.g. supercapacitors) may provide rapid discharge of power over a short period of time, allowing the fuel cell stacks to build current density and to “take over” the buffering operation as the rapid discharge electric storage system discharges. In this way, the rapid discharge electric storage system may allow the use of smaller capacity fuel cell stacks, saving overall system capital costs.

The coordination and power flow of the fuel cell stack, supercapacitor and available DG may be performed autonomously in a manner that optimizes cost and preserves the integrity of system components.

During periods of lower demand or excess available power from distributed generation, energy may be stored in the rapid discharge electric storage system, such as in the supercapacitor banks, and in the fuel storage by engaging electrolyzer functioning. This may performed autonomously.

Sophisticated “digital twin” modeling may also be incorporated into the systems and method described herein. As used herein, a “digital twin” may be a software model which approximates an existing system, such as a power grid or a region of a power grid, and provides approximations of real characteristics and/or states of that system. The digital twin may also provide predictions of future states or characteristics of that system.

The digital twin model may include the microgrid system's own components and/or those of the associated bulk power sub-system. Certain elements of these models may be machine-learning or deep-learning algorithms, which may be trained by a combination of collected data and calculated features, and pre-computed parameters. As a result, the system may anticipate faults and provide notifications of imminent equipment problems or power grid phenomena.

In addition, the need for data security may critical, as erroneous data or maliciously altered data could be disastrous for the microgrid and beyond. However, because the systems and methods described herein operate using mathematical modeling and control theory, effective tampering may be difficult.

Other aspects and implementations of these systems and methods are described in detail herein.

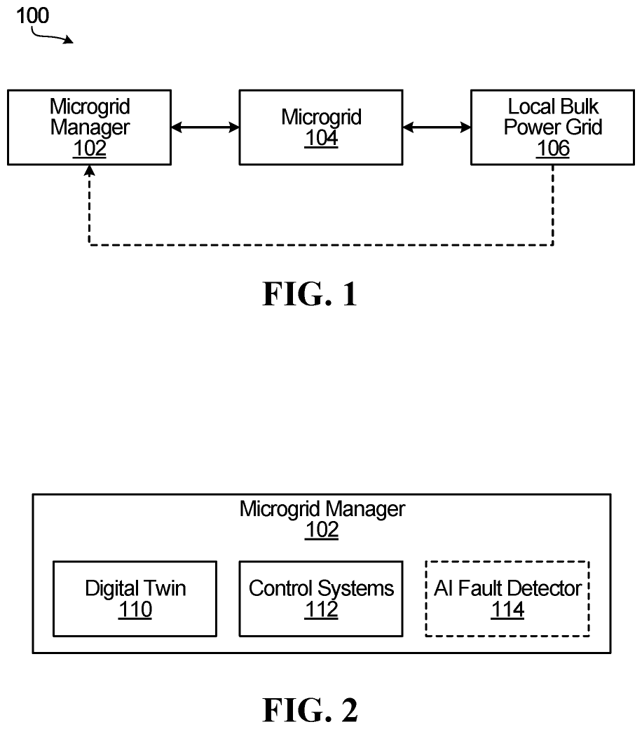

FIG. 1 depicts a microgrid system 100. System 100 includes a microgrid manager 102, a microgrid 104 and a local bulk power grid 106.

Microgrid manager 102 provides instructions and receives information from microgrid 104.

Microgrid manager 102 may be executed on a computing device (not depicted), which may communicate with microgrid 104 over the Internet, a local intranet, a wired connected or some other means.

In some examples, microgrid manager 102 may be hosted on a server, which may communicate with microgrid 104, such as through an Application Programmable Interface (API) or some other means.

Microgrid manager 102 may also receive instructions, information and/or requests for information from other computing devices, such as a user device. For example, an energy operating may use a computing device to send an input condition to microgrid manager 102. The input condition may include instructions and/or requests for information, such as instructions for microgrid 104 to operate in a specific mode. The energy operator may also receive information from microgrid manager 102 using the computing device. Microgrid manager 102 may provide an interface for the energy operator to modify the operation of microgrid 104, schedule future operations of microgrid 104, run diagnostics on microgrid 104, check the operation of microgrid 104 and/or other tasks.

It will be appreciated that microgrid manager 102 may be physically connected to or located within microgrid 104, such as directly connected to a controller within microgrid 104. In some examples, microgrid manager 102 may be hosted on or executed by the microgrid controller.

Microgrid manager 102 may also include modules which may assist with controlling microgrid 104 and/or optimizing the performance of microgrid 104. As depicted in FIG. 2, microgrid manager includes a digital twin 110 and control systems 112. In some implementations, microgrid manager 102 may also include a module for fault detection, such as artificial intelligence (AI) fault detector 114.

Digital twin 110 may model local bulk power grid 106. For example, digital twin 110 may provide include one or more ODEs, state space models, or other AI models which simulate or approximate the actual characteristics and/or performance of local bulk power grid 106. For example, AI models may include machine learning models and/or deep learning models. Deep learning models may include convolutional neural networks, recurrent neural networks and or other types of deep learning models. Machine learning models may include support vector machines (SVMs), K-nearest neighbours (KNN), neural networks, regression, clustering and/or other examples.

In some situations, digital twin 110 may be queried to determine an approximate power, voltage, current, frequency, phase or other electrical characteristics of local bulk power grid 106.

In some implementations, digital twin 110 may also model microgrid 104 and/or one or more components of microgrid 104. For example, it will be appreciated that since microgrid 104 may load local bulk power grid 106, and so digital twin 110 may be designed to model both local bulk power grid 106 and microgrid 104 to accurately approximate local bulk power grid 106.

Control systems 112 may include one or more control systems for controlling the operations of microgrid 104. In some implementations, control systems 112 may control the operations of microgrid 104 in a closed loop. For example, control systems 112 may modify the operation of one or more elements in microgrid 104 and monitor the performance of microgrid 104, such as continuously or at periodic intervals. Further modifications to the operation of the one or more elements in microgrid 104 may be made in response to the monitored performance of microgrid 104.

In some implementations, control systems 112 may be stored, copied to and/or executed on a computing device in microgrid 104, such as a controller.

AI fault detector 114 may include one or more AI models which are trained to detect patterns in digital twin 110, control systems 112, measurements of microgrid 104 and/or measurements of local bulk power grid 106. In response to detecting certain patterns, AI fault detector 114 may predict that a fault is about to occur in microgrid 104 and/or local bulk power grid 106. AI fault detector 114 may also predict the timing, location, circumstances and/or cause of the fault.

AI fault detect may include one or more machine learning models, AI models (e.g. neural networks), classifiers and/or other predicted models. AI fault detector may also include one or more other modules for pre-processing or post-processing input data, predictions and other intermediate data.

Microgrid manager 102 may provide instructions to microgrid 104, such as an input condition. The input condition may include instructions and/or requests for information, such as instructions for microgrid 104 to operate in a specific mode. The input condition may be based on one or more predictions generated by digital twin 110.

Microgrid manager 102 may also send requests for information to microgrid 104. As well, microgrid manager 102 may receive information, such as diagnostics or measurements, from microgrid 104.

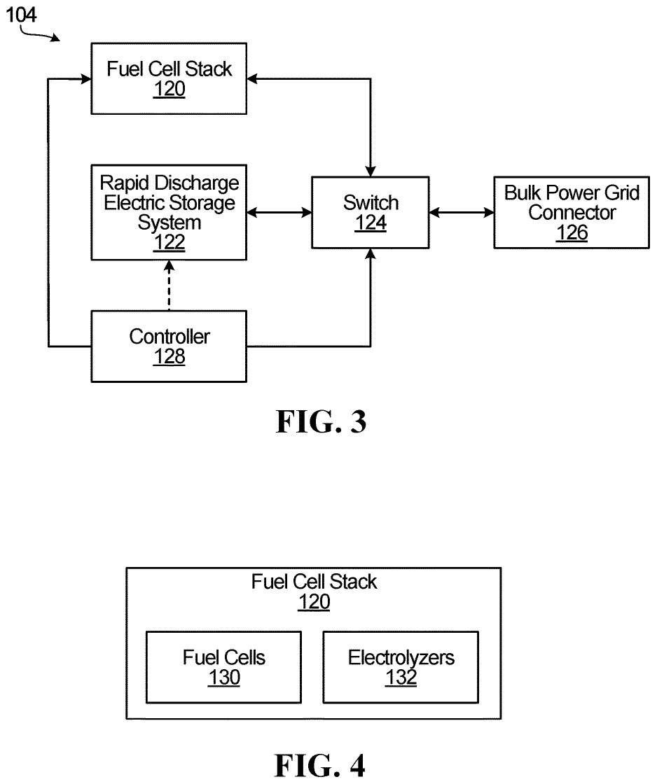

Microgrid 104 is depicted in FIG. 3, according to some implementations. Microgrid 104 includes a fuel cell stack 120, a rapid discharge electric storage system 122, a switch 124, a bulk power grid connector 126 and a controller 128. Microgrid 104 may include additional fuel cell stacks and rapid discharge electric storage systems. Other components may also be included in microgrid 104. For example, microgrid 104 may also include a distributed generator (not depicted) and distributed storage (not depicted). It will be understood that microgrid 104 may be capable of “islanding” itself from local bulk power grid 106 for periods of time. Other forms of storage (not depicted) may also be incorporated into microgrid 104 in an ad hoc manner.

As depicted in FIG. 4, fuel cell stack 120 may include one or more fuel cells 130 (referred to collectively and individually as fuel cells 130) and one or more electrolyzers 132 (referred to collectively and individually as electrolyzers 132). It will be appreciated that fuel cell stack 120 may include more fuel cells than electrolyzers or more electrolyzers than fuel cells.

Fuel cells 130 may include a Reversible Solid Oxide Cell (ReSOC), a Proton Exchange Membrane (PEM) fuel cell, or another example fuel cell. Fuel cells 130 may also include a combination of multiple types of fuel cells.

Fuel cell stack 120 may also include other components (not depicted) in addition to fuel cells 130, such as for power distribution and management, controlling, measuring or interfacing with fuel cells 130 and electrolyzer 132, and for providing other functionality.

In some implementations, electrolyzer may be a reversible fuel cell, such as a ReSOC. In these implementations, fuel cells 130 may also double as electrolyzers 132. As used herein, the term “reversible” means that the fuel cell may both generate electricity from fuel and consume electricity to generate fuel. In particular, fuel cells 130 may be operated in a fuel cell mode or an electrolyzer mode. In the fuel cell mode, fuel cells 130 generate electricity from fuel. In some examples, the fuel may be hydrogen or hydrogen-based. In the electrolyzer mode, fuel cells 130 may generate fuel from electricity. The generated fuel may be hydrogen or hydrogen-based.

In the fuel cell mode, fuel cells 130 may provide a steady discharge of electricity. However, in some examples, fuel cells 130 may take time to build a threshold current density before fuel cells 130 may be used to discharge power.

Rapid discharge electric storage system 122 may be used to provide a rapid discharge of power while fuels cells 130 in fuel cell stack 120 are building the threshold current density. In some implementations, this may improve lifetime and operation of fuel cells 130, as fuel cells 130 may not be required to rapidly discharge power. Instead, rapid discharge electric storage system 122 may be used to handle sudden power demands or changes in power demand.

Rapid discharge electric storage system 122 may include one or more electric storage components. In some implementations, the electric storage components may include supercapacitors. For example, FIG. 5 depicts rapid discharge electric storage system 122 including one or more supercapacitors 134 (referred to collectively and individually as supercapacitors 134). In some implementations, rapid discharge electric storage system may be a supercapacitor bank.

In some further implementations, rapid discharge electric storage system 122 may in addition or instead include one or more magnetic bearing dynamos, a gravity storage system and/or other energy storage components. In some examples, rapid discharge electric storage system 122 may have a low energy storage capacity but capabilities for rapid discharge.

It will be appreciated that rapid discharge electric storage system 122 may be composed of one or more components capable of providing a rapid electric discharge of power. As well, the one or more components in rapid discharge electric storage system 122 may also be rechargeable.

Rapid discharge electric storage system 122 may also include other components (not depicted), such as for power distribution and management, controlling, measuring or interfacing with electric storage components (e.g. supercapacitors), and for providing other functionality.

Fuel cell stack 120 and rapid discharge electric storage system 122 are coupled to switch 124. Switch 124 is also coupled to bulk power grid connector 126. Switch 124 may be used to couple or decouple fuel cell stack 120 and/or rapid discharge electric storage system 122 from bulk power grid connect 126. For example, switch 124 may be “closed” to connect or couple two or more components and “opened” to disconnect or couple the two or more components, e.g. fuel cell stack 120 and/or rapid discharge electric storage system 122 from bulk power grid connect 126.

In some implementations, switch 124 may include one or more relays, solid state switches, circuit breakers and other control switches.

In some implementations, fuel cell stack 120 and rapid discharge electric storage system 122 may be connected to a power bus. In some examples, the power bus may be a direct current (DC) bus. The power bus may also be connected to switch 124. Switch 124 may be used couple or decouple fuel cell stack 120 and/or rapid discharge electric storage system 122 from bulk power grid connector 126, such as by coupling or connecting the power bus bulk power grid connector 126.

In some other implementations, switch 124 may include a plurality of switches. For example, switch 124 may include a first switch and fuel cell stack 120 may be connected to a power bus through the first switch. Switch 124 may also include a second switch and rapid discharge electric storage system 122 may be connected to a power bus through the second switch. The first switch and the second switch may each be connected or coupled to a power bus. Switch 124 may also include a third switch and bulk power grid connector 126 may be connected or coupled to the power bus through the third switch. In this way, each of the first, second and third switches in switch 124 may be used to connect or couple at least one of fuel cell stack 120, rapid discharge electric storage system 122 and bulk power grid connect 126.

Bulk power grid connector 126 may provide a connect to local bulk power grid 106.

As noted above, microgrid 104 may also include a power converter and/or one or more transformers (not depicted), which may be connected or coupled to bulk power grid connector 126. For example, the power converter may be used to convert DC power from a DC power bus connected or coupled to fuel cell stack 120 and rapid discharge electric storage system 122 to alternating current (AC) power (inversion). The power converter may also be used to converter AC power to DC power (regulation or rectification). For example, the AC voltage levels may be 600 V, 13.8 kV or higher. The AC voltage level may also be three-phase and the voltage levels may be 600 VRMS. Other AC voltage levels are possible. One or more transformers may be used to step down the higher voltage from local bulk power grid 106 to a lower voltage more appropriate for the components in microgrid 104, such as fuel cell stack 120 and/or rapid discharge electric storage system 122. Similarly, the one or more transformers may step up the lower voltage of microgrid 104 to a higher voltage for local bulk power grid 106.

Generally, the transformers may mediate between microgrid 104 and local bulk power grid 106. As already discussed, the power converter may provide both inversion (DC to AC) and regulation or rectification (AC to DC) for microgrid 104. This may allow microgrid 104 to provide power that is phase-and frequency-compatible with local bulk power grid 106. This may also allow microgrid 104 to convert power from local bulk power grid 106 into DC voltage that can be used to drive electrolyzers or battery charging circuits in microgrid 104.

In some further implementations of microgrid 104, the third switch in switch 124 may not be directly connected to the power bus. For example, the third switch may be connected between the power converter in microgrid 104 and the bulk power grid connector 126. The third switch may also be connected between the power converter and the one or more transformers in microgrid 104, or between one or more other components. It will be appreciated that if the third switch is situated in microgrid 104 before the one or more transformers step up the voltage level, the third switch may have more lenient voltage requirements.

Microgrid 104 also includes controller 128, which may be used to toggle switch 124 from an open position to a closed position. In implementations where switch 124 includes a plurality of switches, controller 128 may be used to individually or collective open or close the switches. As such, controller 128 may be in communication with switch 124, such as through a digital bus or data bus.

Controller 128 may also be used to configure or control the operating model of fuel cell stack 120. For example, controller 128 may be used to configure fuel cell stack 120 to operate in the fuel cell mode or the electrolyzer mode. Controller 128 may also be in communication with fuel cell stack 120, such as through a digital bus or data bus.

In some other implementations, controller 128 may also be in communication with rapid discharge electric storage system 122 and/or one or more other components in microgrid 104.

In some implementations, microgrid manager 102 may be hosted by or executed on controller 128. For example, controller 128 may be a computing device, and the computing device may include microgrid manager 102. In other implementations, only some portions of controller 128 may be hosted by or executed on controller 128, such as digital twin 110, control systems 112 and/or AI fault detector 114.

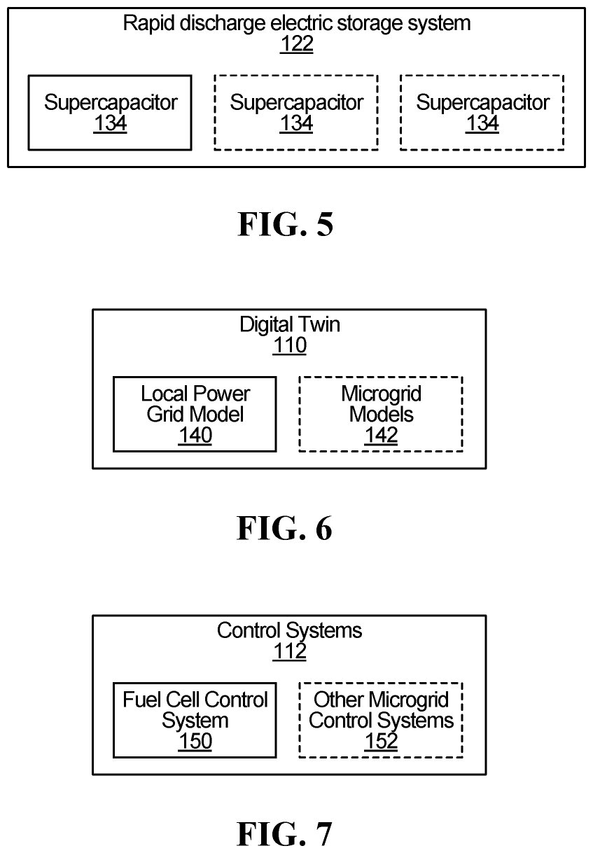

Local bulk power grid 106 may be modelled by digital twin 110. For example, FIG. 6 depicts an example block diagram of digital twin 110. Digital twin 110 includes a local power grid model 140, which may approximate the past, present or future performance of local bulk power grid 106. As such, digital twin 110 may be used to predict certain voltage, current, power, frequency or phase characteristics of local bulk power grid 106 based on local power grid model 140.

Since local bulk power grid 106 may be coupled to microgrid 104 through bulk power grid connector 126, microgrid 104 may load local bulk power grid 106. As such, local power grid model 140 may also approximate the characteristics of local bulk power grid 106 while loaded with microgrid 104, and therefore aspects of microgrid 104 may also be included in local power grid model 104. In some implementations, digital twin 110 may also be used to predict certain voltage, current, power, frequency, phase or thermal characteristics of microgrid 104 based on local power grid model 140.

In some other implementations, digital twin 110 may also include microgrid models 142. Microgrid models 142 may include one or more models of microgrid 104 with and/or without the loading of local bulk power grid 106, such as when switch 124 is used to couple and/or decouple microgrid 104 from local bulk power grid 106, respectively. Microgrid models 142 may also or instead include models for fuel cell stack 120, rapid discharge electric storage system 122 and/or other components or combinations of components in microgrid 104. As such, digital twin 110 may be used to predict certain voltage, current, power, frequency, phase or thermal characteristics of components in microgrid 104 based on microgrid models 142.

As noted above, digital twin 110 may generate predictions of performance for local bulk power grid 106, microgrid 104 and/or components of microgrid 104. Microgrid manager 102 may transmit these predictions to microgrid 104. Microgrid manager 102 may also generate an input condition based on one or more predictions generated by digital twin 110.

For example, digital twin 110 may predict duress in local bulk power grid 106, such as an increased power demand which local bulk power grid 106 may be unequipped to handle or have difficulty handling. In response to the prediction of duress in local bulk power grid 106, microgrid manager 102 may generate an input condition which includes an instruction for microgrid 104 to enter an energy buffering mode. The energy buffering mode may cause microgrid 104 to provide additional power to local bulk power grid 106 to assist during the predicted duress condition. Microgrid manager 102 may transmit the input condition including the energy buffering mode to microgrid 104, such as to controller 128 in microgrid 104.

In other examples, digital twin 110 may predict excess power in local bulk power grid 106, such as reduced power demand from local bulk power grid 106 and/or an excess of available power in local bulk power grid 106. In response to the prediction of excess power in local bulk power grid 106, microgrid manager 102 may generate an input condition which includes an instruction for microgrid 104 to enter an energy storage mode. The energy storage mode may cause microgrid 104 to provide additional power to local bulk power grid 106 to assist during the predicted excess power condition. Microgrid manager 102 may transmit the input condition including the energy storage mode to microgrid 104, such as to controller 128 in microgrid 104.

It will be appreciated that digital twin 110 may predict current and/or future excess power or duress conditions, and so microgrid manager 102 may transmit one or more input conditions to microgrid 104 with scheduled times for microgrid 104 to enter the energy storage or energy buffering modes. Microgrid manager 102 may also transmit end conditions for the energy storage or energy buffering modes, such as a duration of time, a power, voltage, current, thermal or other condition, etc.

Digital twin 110 may also predict other conditions in local bulk power grid 106, and input conditions may also include other modes of operation for microgrid 104.

Similarly, digital twin 110 may also prediction conditions in microgrid 104, and input conditions may also include the energy storage mode, the energy buffering mode, and/or other operating conditions for microgrid 104 based on the predictions for microgrid 104.

In some further implementations, a computing device may transmit an instruction to microgrid manager 102, such as a computing device associated with an energy operator. The instruction may include an input condition, which may include the energy storage mode, the energy buffering mode and/or other operating conditions for microgrid 104. For example, an operator may send an instruction to microgrid manager 102 to schedule microgrid 104 to operate in an energy storage mode and/or energy buffering mode at a future time. Microgrid manager 102 may transmit this input condition to microgrid 104.

Controller 128 in microgrid 104 may receive the input condition. In response to receiving the input condition, controller 128 may configure fuel cell stack 120 and rapid discharge electric storage system 122. For example, controller 128 may set operating conditions of fuel cell stack 120 and rapid discharge electric storage system 122 based on the input condition. Controller 128 may also monitor performance of fuel cell stack 120 and rapid discharge electric storage system 122 in a closed loop, such as using control systems 112.

In response to receiving an input condition including an energy buffering mode, controller 128 may configure fuel cell stack 120 and rapid discharge electric storage system 122 to operate in the energy buffering mode.

In some implementations, the energy buffering mode may include coupling, for a first time period, rapid discharge electric storage system 122 to local bulk power grid 106, such as by controller 128 toggling switch 106 (or one or more switches within switch 106) to couple rapid discharge electric storage system 122 with bulk power grid connector 126. Controller 128 may also decouple fuel cell stack 120 from local bulk power grid connector 126 using switch 106. Rapid discharge electric storage system 122 may provide a rapid discharge of power to local bulk power grid 106, such as through bulk power grid connector 126.

The energy buffering mode may also include coupling, for a second time period, fuel cell stack 120 to local bulk power grid 106, such as by controller 128 toggling switch 106 (or one or more switches within switch 106) to couple fuel cell stack 120 with bulk power grid connector 126. Controller 128 may also configure fuel cell stack 120 to operate in a fuel cell mode and to provide a steady discharge of power to local bulk power grid 106. It will be appreciated that fuel cells 130 in fuel cell stack 120 may be active while fuel cell stack 120 operates in the fuel cell mode.

It will be appreciated that rapid discharge electric storage system 122 may still provide a discharge of power to local bulk power grid 106 during the beginning of the second period, such as to ensure a smooth or gradual handoff between rapid discharge electric storage system 122 and fuel cell stack 120. During this initial time of second time period, rapid discharge electric storage system 122 may remain coupled with bulk power grid connector 126. However, switch 106 (or one or more switches within 106) may be toggled to decouple rapid electric storage system 122 from bulk power grid connector 126 after rapid electric storage system 122 is fully or nearly discharged.

In some implementations, controller 128 may configure fuel cell stack 120 to build current density during the first time period, such that fuel cell stack 120 has a sufficient current density before discharging power to local bulk power grid 106. Controller 128 may toggle switch 106 (or one or more switches within switch 106) to decouple fuel cell stack 120 from bulk power grid connector 126 during this time period, as noted above. Allowing fuel cell stack 120 to build up sufficient current density before discharge may help increase the lifespan of fuel cell stack 120 and/or the individual fuel cells in fuel cell stack 120.

In response to receiving an input condition including an energy storage mode, controller 128 may configure fuel cell stack 120 and rapid discharge electric storage system 122 to operate in the energy storage mode.

In some implementations, the energy storage mode may include charging rapid discharge electric storage system 122 with excess power from local bulk power grid 106, such as by controller 128 toggling switch 106 (or one or more switches within switch 106) to couple rapid discharge electric storage system 122 with bulk power grid connector 126.

Controller 128 may also configure fuel cell stack 120 to operate in the electrolyzer mode, such as by providing an instruction to logic circuitry included within fuel cell stack 120 and/or adjusting voltage, current, thermal or other characteristics of fuel cell stack 120. It will be appreciated that electrolyzers 132 in fuel cell stack 120 may be active while fuel cell stack 120 operates in the electrolyzer mode. As noted above, in some implementations fuel cells 130 may be reversible, and so fuel cells 130 may also double as electrolyzers 132 in the electrolyzer mode.

Fuel cell stack 120 may also generate fuel from excess power in local bulk power grid 106. Controller 128 may toggle switch 106 (or one or more switches in switch 106) to couple fuel cell stack 120 to bulk power grid connector 126. The fuel generated by fuel cell stack 120 in the electrolyzer mode by fuel cell stack may be hydrogen, hydrogen-based or some other type of fuel.

FIG. 7 depicts a block diagram of control systems 112, according to some implementations. Control systems 112 may include fuel cell control system 150. Control systems 112 may also include other microgrid control systems 152. It will be appreciated that control systems 112 may be hosted on or executed by controller 128.

Fuel cell control system 150 may include one or more state space models, one or more ODEs and/or other models to help control the operation of microgrid 104 in response to input conditions and other operations. In particular, fuel cell control system 150 may be used to adjust and monitor the operating parameters of fuel cell stack 120 to maintain a certain operating mode or operating conditions. For example, fuel cell control system 150 may be used to configure fuel cell stack 120 in the fuel cell mode or the electrolyzer mode, to maintain fuel cell stack 120 within a certain thermal condition, to prolong the lifespan of fuel cell stack 120, or to achieve other performance goals.

In some implementations, fuel cell control system 150 may include one or more control systems, such a control system for each of fuel cells 130 and/or electrolyzers 132.

Fuel cell control system 150 may also be used to ensure that fuel cell stack 120 responds to input conditions, instructions or commands from controller 128 within a certain time period. This may also help ensure that microgrid 104 responds to input conditions or instructions within that time period or another time period.

In some implementations, fuel cell control system 150 may also help ensure that fuel cell stack responds to input conditions as slowly as possible within this time period to help preserve the lifespan of fuel cell stack 120 and/or other components in microgrid 104. For example, fuel cell stack 120 may respond to input conditions as slowly as possible within the time period to reduce the flow rate of fuel (e.g. hydrogen and/or oxygen) to fuel cells 130 and reduce temperature stress on fuel cell stack 120, helping increase the lifespan of fuel cell stack 120.

Fuel cell control system 150 may also be tuneable, such that the response time and performance of fuel cell stack 120 may be tuned through fuel cell control system 150.

Other microgrid control systems 152 may also include one or more state space models, one or more ODEs and/or other models to help control the operation of microgrid 104 in response to input conditions and other operations. For example, other microgrid control systems 152 may include a control system for rapid discharge electric storage system 122.

Other microgrid control systems 152 also be tuneable, such that the response time and performance of components within microgrid 104 (e.g. rapid discharge electric storage system 122 or a power converter) may be tuned through other microgrid control systems 152.

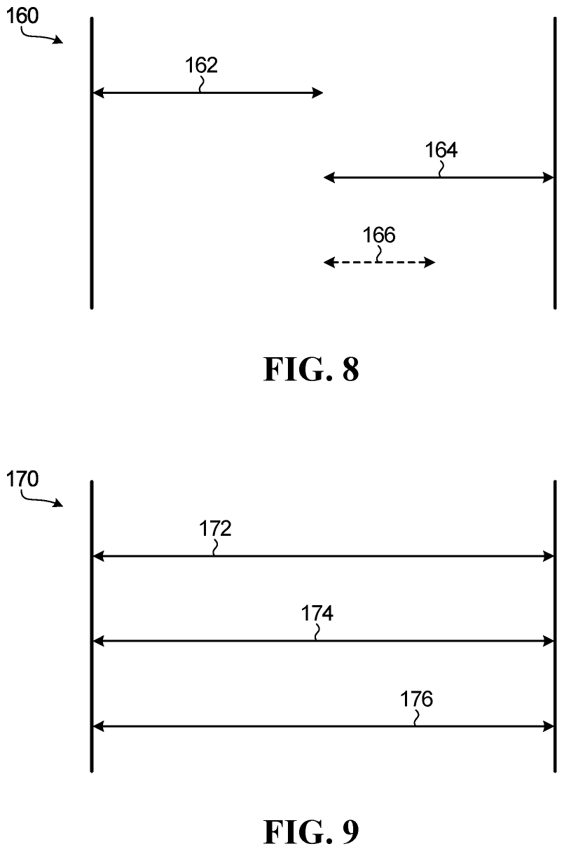

As discussed above, controller 128 may configure fuel cell stack 120 and rapid discharge electric storage system 122 to operate in an energy buffering mode. FIG. 8 depicts a flow diagram of an energy buffering mode 160, according to some embodiments. Energy buffering mode 160 includes a first time period 162 and a second time period 164. Energy buffering mode 160 may also include a third time period 166.

Energy buffering mode 160 may configure fuel cell stack 120 and rapid discharge electric storage system 122 to provide power to local bulk power grid 106, such as to help alleviate the burden on local bulk power grid 106.

In first time period 162, controller 128 couples rapid discharge electric storage system 122 to local bulk power grid 106, such as by toggling switch 124. During first time period 162, rapid discharge electric storage system 122 provides a rapid discharge of power to local bulk power grid 106.

In some implementations, controller 128 may also configure fuel cell stack 120 to build current density during first period 162, such that fuel cell stack 120 build an appropriate current density before discharging power to local bulk power grid 106.

In second time period 164, controller 128 couples fuel cell stack 120 to local bulk power grid 106, such as by toggling switch 124. During second time period 164, fuel cell stack 120 operates in the fuel cell mode and provides a steady discharge of power to local bulk power grid 106. It will be appreciated that controller 128 may configure fuel cell stack 120 to operate in the fuel cell mode.

It will be appreciated that rapid discharge electric storage system 122 may continue to discharge power within a first portion of second time period 164. For example, energy buffering mode 160 may optionally include third time period 166, which begins at the start of second time period 164 and ends sometime during second time period 164. Rapid discharge electric storage system 122 may continue to discharge power to local bulk power grid 106 during third time period 166, such as to ensure a gradual or continuous handoff between rapid discharge electric storage system 122 and fuel cell stack 120.

Controller 128 may additionally or instead configure any number of other components in microgrid 104 during energy buffering mode 160. Additional or fewer time periods may be included in energy buffering mode 160, and the time periods may also occur in a different order in energy buffering mode 160 than those discussed above. As well, first time period 162, second time period 164 and/or third time period 166 may also be combined into one or more time periods.

As discussed above, controller 128 may configure fuel cell stack 120 and rapid discharge electric storage system 122 to operate in an energy storage mode. FIG. 9 depicts a flow diagram of an energy storage mode 170, according to some embodiments. Energy storage mode 170 includes a first phase 172, a second phase 174 and a third phase 176.

First phase 172, second phase 174 and third phase 176 may occur simultaneously or at different times in energy storage mode 170. First phase 172, second phase 174 and third phase 176 may also occur for different durations or for the same duration.

Energy storage mode 170 may configure fuel cell stack 120 and rapid discharge electric storage system 122 to draw excess power from local bulk power grid 106, such as to charge rapid discharge electric storage system 122 and generate fuel from the excess power using fuel cell stack 120.

In first phase 172, controller 128 configures microgrid 104 for rapid discharge electric storage system 122 to charge with excess power from local bulk power grid 106. Controller 128 may toggle switch 128 (or one or more of switches 128) such that rapid discharge electric storage system 122 charges. Controller 128 may also toggle additional components in microgrid 104 in first phase 172.

In second phase 174, controller 128 configures fuel cell stack 120 to operate in an electrolyzer mode. Controller 128 may also toggle additional components in microgrid 104 in second phase 174.

In third phase 176, controller 128 configures fuel cell stack 120 to generate fuel from the excess power in local bulk power grid 106. For example, controller 128 may toggle switch 128 (or one or more switches of switch 128) to couple or connect fuel cell stack 120 and local bulk power grid 106.

Controller 128 may additionally or instead configure any number of other components in microgrid 104 during energy buffering storage 170. Additional or fewer phases may be included in energy storage mode 170, and the phases may also occur in a different order in energy storage mode 170 than those discussed above. As well, first phase 172, second phase 174 and third phase 176 may also be combined into one or more phases.

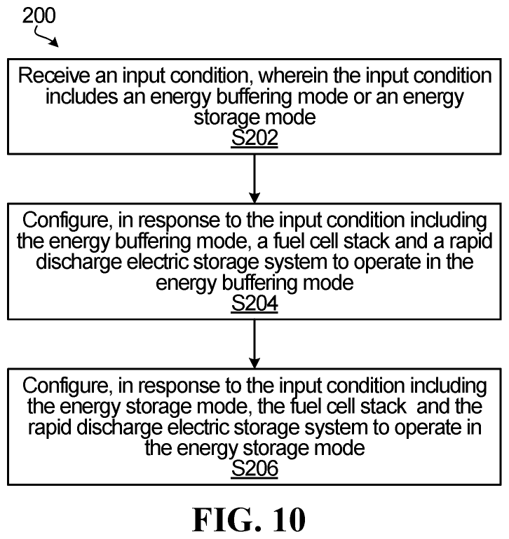

FIG. 10 depicts a method 200, which may be performed by system 100. In other implementations, microgrid manager 102 and microgrid 104 may perform method 200. For example, microgrid manager 102 may provide instructions to microgrid 104 and receive information from microgrid 104. In further implementations, method 200 may be performed just by microgrid 104.

At step S202, an input condition is received. The input condition includes an energy buffering mode or an energy storage mode.

The input condition may be received by microgrid 104, such as by controller 128 in microgrid 104.

The input condition may be received from microgrid manager 102, such as over the Internet, intranet, a wired connection, Bluetooth or some other wireless or wired connection. For example, input condition may be received through an API or some other software or website interface.

In some implementations, microgrid manager 102 or portions of microgrid manager 102 may be hosted or located within microgrid 104. In these implementations, controller 128 may receive input condition over a data bus.

Input condition may includes energy buffering mode 160 or energy storage mode 170. In some examples, input condition may contain just one of energy buffering mode 160 or energy storage mode 170. In other examples, input condition may include both energy buffering mode 160 and energy storage mode 170. Input condition may also include other information, such as a scheduled time for microgrid 104 to be configured in the specified mode or input condition, a duration of time for the configuration, an end condition for the configuration, and other operational settings for microgrid 104 and/or any components in microgrid 104. Input condition may also include other instructions or requests for information from microgrid 104 or its components, such as controller 128.

It will be understood that input condition may include an instruction for controller 128 to configure components of microgrid 104 into energy buffering mode 160 or energy storage mode 170.

In some examples, input condition may be automatically generated by microgrid manager 102, such as by digital twin 110, control systems 112 and/or AI fault detector 114. Microgrid manager 102 may transmit input condition directly to microgrid 104 after receiving a prediction from digital twin 110 or AI fault detector 114. In other examples, digital twin 110 and/or AI fault detector 114 may transmit the prediction to control systems 112, which may generate a portion or all of the input condition which microgrid manager 102 transmits to microgrid 104.

As noted above, the input condition may be based on a prediction generated by digital twin 110, which may model local bulk power grid 106. The prediction may include a prediction of duress or a prediction of excess power in local bulk power grid 106. The prediction of excess power may also include a prediction of reduced power demand from local bulk power grid 106. The prediction may include a predicted time of the duress or excess power condition in local bulk power grid 106, a predicted location or region in the grid of the predicted condition, a predicted duration of the predicted condition, etc. The prediction may also pertain to other conditions in local bulk power grid 106. The prediction may also include other predictions about the performance of local bulk power grid 106.

In situations where digital twin 110 predicts duress in local bulk power grid 106, the input condition may include energy buffering mode 160 responsive to the prediction. In situations where digital twin 110 predicts excess power in local bulk power grid 106, the input condition may include energy storage 170 mode responsive to the prediction.

Digital twin 110 may also model fuel cell stack 120 and/or rapid discharge electric storage system 122. Digital twin 110 may also model other components in microgrid 104.

In some implementations, digital twin 110 may generate a prediction based on modelling of microgrid 104 or both local bulk power grid 106 and microgrid 104. In these implementations, the prediction generated by digital twin 110 may also include other predictions about performance of both local bulk power grid 106 and microgrid 104.

In other examples, microgrid manager 102 may receive a measurement of local bulk power grid 106 indicating that local bulk power grid 106 is experiencing or about to experience a condition of duress or excess power. Input condition may also be generated based on this measurement, such that input condition includes energy buffering mode 160 responsive to a measurement of duress or energy storage mode 170 responsive to a measurement of excess power in local bulk power grid 106.

In other examples, microgrid manager 102 may receive an instruction from a computing device, such as one associated with an energy operator. Microgrid manager 102 may relay or transmit the instruction directly to microgrid 104 as an input condition. In these situations, the computing device may directly transmit the input condition to microgrid manager 102. In other implementations, microgrid manager 102 may generate input condition based on the instruction from the computing device, such as using control systems 112.

At step S204, in response to the input condition including the energy buffering mode, a fuel cell stack and a rapid discharge electric storage system are configured to operate in the energy buffering mode.

For example, controller 128 may receive input condition and determine that input condition includes energy buffering mode 160. Controller 128 may configure fuel cell stack 120 and rapid discharge electric storage system 122 responsive to receiving the input condition and based on the contents of input condition, i.e. to configure fuel cell stack 120 and rapid discharge electric storage system 122 in energy buffering mode 160.

In other examples, controller 128 may receive an instruction based on the input condition. In particular, the instruction may be generated based on energy buffering 160 mode contained within input condition, and the instruction may instruct controller 128 to configure fuel cell stack 120 and rapid discharge electric storage system 122 into the energy buffering mode.

The input condition may include other instructions or operating settings, which controller 128 may also use to configure fuel cell stack 120 and rapid discharge electric storage system 122.

As discussed briefly above, energy buffering mode 160 may be used to address a prediction, measurement or indication of duress in local bulk power grid 106. Energy buffering mode 160 may configure fuel cell stack 120 and rapid discharge electric storage system 122 to provide power to local bulk power grid 106 during this condition, such as to help alleviate the burden on local bulk power grid 106.

At step S206, in response to the input condition including the energy storage mode, the fuel cell stack and the rapid discharge electric storage system are configured to operate in the energy storage mode.

For example, controller 128 may receive input condition and determine that input condition includes energy storage mode 170. Controller 128 may configure fuel cell stack 120 and rapid discharge electric storage system 122 responsive to receiving the input condition and based on the contents of input condition, i.e. to configure fuel cell stack 120 and rapid discharge electric storage system 122 in energy storage mode 170.

In other examples, controller 128 may receive an instruction based on the input condition. In particular, the instruction may be generated based on energy storage mode 170 contained within input condition, and the instruction may instruct controller 128 to configure fuel cell stack 120 and rapid discharge electric storage system 122 into energy storage mode 170.

The input condition may include other instructions or operating settings, which controller 128 may also use to configure fuel cell stack 120 and rapid discharge electric storage system 122.

As discussed briefly above, energy storage mode 170 may be used to address a prediction, measurement or indication of excess power in local bulk power grid 106 (e.g. a reduced power demand from local bulk power grid 106). Energy storage mode 170 may configure fuel cell stack 120 and rapid discharge electric storage system 122 to draw excess power from local bulk power grid 106 during this condition, such as to charge rapid discharge electric storage system 122 and generate fuel from the excess power using fuel cell stack 120.

It will be appreciated that only one of steps S204 and S206 may be executed by method 200, depending on the input condition received. For example, if the input condition includes energy buffering mode 160 but not energy storage mode 170, then only step S204 may be executed by method 200. As well, if the input condition includes energy storage mode 170 but not energy buffer mode 160, then only step S206 may be executed by method 200. However, if the input condition includes both energy buffering mode 160 and energy storage mode 170, then both steps S204 and S206 may be executed by method 200.

Configuring fuel cell stack 120 and rapid discharge electric storage system 122, such as into the energy buffering mode and/or energy buffer mode described in steps S204 and S206, respectively, may also include a controller setting operating conditions of fuel cell stack 120 and rapid discharge electric storage system 122 based on the input condition. Configuring fuel cell stack 120 and rapid discharge electric storage system 122, such as in steps S204 and S206, may also include monitoring the performance of fuel cell stack 120 and rapid discharge electric storage system 122 in a closed loop.

Method 200 described above may also include the additional step of detecting, using an AI model, a fault signature in at least one of a measurement or prediction corresponding to local bulk power grid 106. Method 200 may further include the step of configuring, such as using controller 128, the operating conditions of fuel cell stack 120 and rapid discharge electric storage system 122 based on the detected fault signature. For example, and as already noted above, the input condition may be based on a prediction generated by AI fault detector 114. AI fault detector 114 may detect a fault signature in at least one of a measurement or prediction (e.g. generated by digital twin 110) corresponding to local bulk power grid 106 and/or microgrid 104. Controller 128 may configure the operating conditions of fuel cell stack 120 and rapid discharge electric storage system 122 based on the fault signature detected by AI fault detector 114.

Method 200 may include any number of additional steps not described above. As well, method 200 may include fewer steps than those described above.

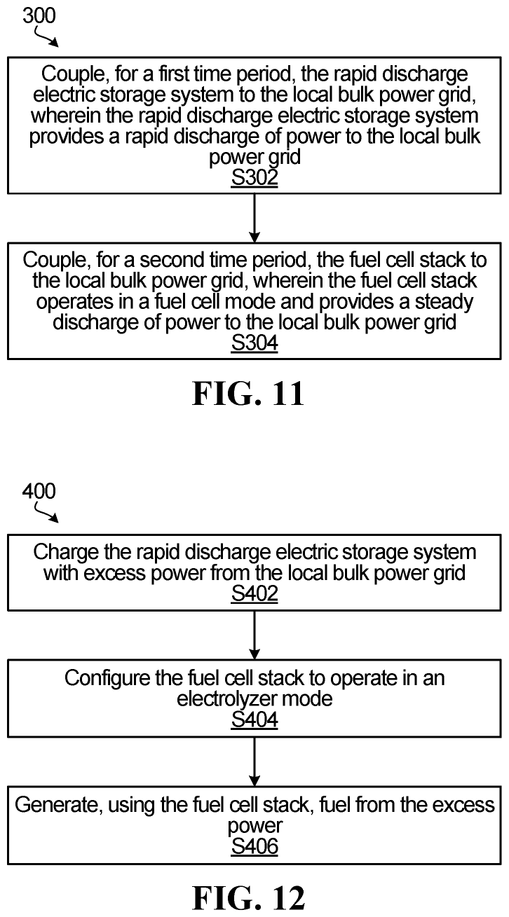

FIG. 11 depicts a method 300 for configuring a fuel cell stack and a rapid discharge electric storage system into the energy buffering mode in step S204 of method 200. Method 300 may be performed with method 200. In other implementations, method 300 may also be performed independently of method 200.

Method 300 may be performed by system 100. In other implementations, microgrid manager 102 and microgrid 104 may perform method 300. For example, microgrid manager 102 may provide instructions to microgrid 104 and receive information from microgrid 104. In further implementations, method 300 may be performed just by microgrid 104.

At step S302, the rapid discharge electric storage system is coupled to the local bulk power grid for a first time period, wherein the rapid discharge electric storage system provides a rapid discharge of power to the local bulk power grid.

For example, controller 128 may instruct switch 124 to a closed configuration, such that rapid discharge electric storage system 122 is coupled to bulk power grid connector 126. Bulk power grid connector 126 may be connected to or coupled to local bulk power grid 106, such that rapid discharge electric storage system 122 and local bulk power grid 106 are coupled. This may allow rapid discharge electric storage system 122 to provide a rapid discharge of power to local bulk power grid 106.

It will be appreciated that switch 124 may include one or more switches.

In some implementations, rapid discharge electric storage system 122 may be connected or coupled to a power bus, such as a DC bus. The power bus may be connected to switch 124. Switch 124 may also be connected or coupled to bulk power grid connector 126, such as through a power converter, one or more transformers and/or one or more other components. Closing switch 124 (or one or more of the switches of switch 124) may connect or couple rapid discharge electric storage system 122 to bulk power grid connector 126.

It will be appreciated that switch 124 (or one or more of the switches of switch 124) may be in the open configuration before controller 128 instructs switch 124 to close at the start of the first period, such that rapid discharge electric storage system 122 and bulk power grid connector 126 are decoupled or disconnected before the first period.

First period 162 may last for an indeterminate period of time. The length of first period 162 may be determined by controller and/or specified by the input condition. Control systems 112 may determine the appropriate length of first period 162, such as based on monitoring the performance of one or more components in microgrid 104 and/or local bulk power grid 106 before and/or after initiating first period 162.

It will be appreciated that fuel cell stack 120 may be disconnected or decoupled from bulk power grid connector 126 at the start of first period 162. If fuel cell stack 120 is not disconnected or decoupled from bulk power grid connector 126 at the start of the first period, controller 128 may instruct switch 124 (or one or more of the switches of switch 124) to disconnect or decouple fuel cell stack 120 and bulk power grid connector 126. Fuel cell stack 120 may remain disconnected or decoupled from bulk power grid connector 126 for the duration of first period 162.

In some implementations, controller 128 may instruct fuel cell stack 120 to build current density during first period 162, before discharging power to local bulk power grid 106. As discussed above, it may be beneficial for the lifespan or health of components in microgrid 104, such as fuel cell stack 120, for fuel cell stack 120 to only discharge power once it has built an appropriate current density. Rapid discharge electric storage system 122 may help fuel cell stack 120 build this current density by providing a rapid discharge of power for first time period 162, such that local bulk power grid 106 receives power without waiting for fuel cell stack 120 to build the current density.

At step S304, the fuel cell stack is coupled to the local bulk power grid, wherein the fuel cell stack operates in a fuel cell mode and provides a steady discharge of power to the local bulk power grid.

For example, controller 128 may instruct switch 124 (or one or more switches of switch 124) to close, such that fuel cell stack 120 is coupled to bulk power grid connector 126. Bulk power grid connector 126 may be connected to or coupled to local bulk power grid 106, such that fuel cell stack 120 and local bulk power grid 106 are coupled. This may allow fuel cell stack 120 to provide a steady discharge of power to local bulk power grid 106.

In some implementations, fuel cell stack 120 may be connected or coupled to a power bus, such as a DC bus. The power bus may be connected to switch 124. Switch 124 may also be connected or coupled to bulk power grid connector 126, such as through a power converter, one or more transformers and/or one or more other components. Closing switch 124 (or one or more of the switches of switch 124) may connect or couple fuel cell stack 120 to bulk power grid connector 126.

In some implementations, the power bus may also be connected to rapid discharge electric storage system 122, such that fuel cell stack 120 and rapid discharge electric storage system 122 share the same power bus. One or more switches in switch 124 may be used to couple, connect, decouple or disconnect fuel cell stack 120 and rapid discharge electric storage system 122 from the power bus.

It will be appreciated that switch 124 (or one or more of the switches of switch 124) may be in the open configuration before controller 128 instructs switch 124 to close at the start of second period 164, such that fuel cell stack 120 and bulk power grid connector 126 are decoupled or disconnected before second period 164.

Second period 164 may last for an indeterminate period of time. The length of second period 164 may be determined by controller and/or specified by the input condition. Control systems 112 may determine the appropriate length of second period 164, such as based on monitoring the performance of one or more components in microgrid 104 and/or local bulk power grid 106 before and/or after initiating first period 162 or second period 164.

In some implementations, the switch 124 (or one or more of the switches of switch 124) remains closed to couple or connect rapid discharge electric storage system 122 to bulk power grid connector 126 during a starting period of second time period 164. For example, rapid discharge electric storage system 122 and bulk power grid connector 126 may remain coupled or connected for third time period 166 overlapping with second time period 164, where third time period 166 begins at the start of second time period 164 and ends sometime during second time period 166. During third time period 166, rapid discharge electric storage system 122 may continue to rapidly discharge power to local bulk power grid 106 even while fuel cell stack 120 discharges power to local bulk power grid 106. Third time period 166 may insure a gradual or continuous handoff between rapid discharge electric storage system 122 and fuel cell stack 120.

Controller 128 may modify or tune the duration of third time period 166, such as depending on the duration of first time period 162, the duration of second time period 164, the performance of microgrid 104 and/or local bulk power grid 106 during first time period 162 and second time period 164, and/or other considerations.

Method 300 may include any number of additional steps not described above. As well, method 300 may include fewer steps than those described above. The steps described above in method 300 may also be performed in a different order than that described above and/or may be combined into fewer steps.

FIG. 12 depicts a method 400 for configuring a fuel cell stack and a rapid discharge electric storage system into the energy stroage mode in step S206 of method 200. Method 400 may be performed with method 200 and/or method 300. In other implementations, method 300 may also be performed independently of method 200 and or method 300.

Method 400 may be performed by system 100. In other implementations, microgrid manager 102 and microgrid 104 may perform method 400. For example, microgrid manager 102 may provide instructions to microgrid 104 and receive information from microgrid 104. In further implementations, method 400 may be performed just by microgrid 104.

At step S402, the rapid discharge electric storage system with excess power from the local bulk power grid.

For example, controller 128 may instruct switch 124 to a closed configuration, such that rapid discharge electric storage system 122 is coupled to bulk power grid connector 126. Bulk power grid connector 126 may be connected to or coupled to local bulk power grid 106, such that rapid discharge electric storage system 122 and local bulk power grid 106 are coupled. This may allow rapid discharge electric storage system 122 to charge from excess power provided by local bulk power grid 106. Controller 128 may also toggle additional components in microgrid 104.

It will be appreciated that switch 124 may include one or more switches.

In some implementations, rapid discharge electric storage system 122 may be connected or coupled to a power bus, such as a DC bus. The power bus may be connected to switch 124. Switch 124 may also be connected or coupled to bulk power grid connector 126, such as through a power converter, one or more transformers and/or one or more other components. Closing switch 124 (or one or more of the switches of switch 124) may connect or couple rapid discharge electric storage system 122 to bulk power grid connector 126.

It will be appreciated that switch 124 (or one or more of the switches of switch 124) may be in the open configuration before controller 128 instructs switch 124 to close, such that rapid discharge electric storage system 122 and bulk power grid connector 126 are decoupled or disconnected before step S402.

Rapid discharge electric storage system 122 may charge for an indeterminate period of time. The length of the charging time may be determined by controller and/or specified by the input condition. Control systems 112 may determine the appropriate charging time, such as based on measurements of the voltage or other characteristics of rapid discharge electric storage system 122, the performance of one or more other components in microgrid 104 and/or local bulk power grid 106, etc.

It will be appreciated that step S402 may be performed in first phase 172 of energy storage mode 170.

At step S404, the fuel cell stack may be configured to operate in an electrolyzer mode.

For example, controller 128 may instruct switch 124 (or one or more switches of switch 124) to close, such that fuel cell stack 120 is coupled to bulk power grid connector 126. Bulk power grid connector 126 may be connected to or coupled to local bulk power grid 106, such that fuel cell stack 120 and local bulk power grid 106 are coupled. This may allow fuel cell stack 120 to provide a steady discharge of power to local bulk power grid 106.

Controller 128 may also configure fuel cell stack 120 to operate in the electrolyzer mode, such that fuel cell stack 120 may generate fuel (e.g. hydrogen or a hydrogen-based fuel) from excess power on local bulk power grid 106. Controller 128 may also toggle additional components in microgrid 104.

In some implementations, fuel cell stack 120 may be connected or coupled to a power bus, such as a DC bus. The power bus may be connected to switch 124. Switch 124 may also be connected or coupled to bulk power grid connector 126, such as through a power converter, one or more transformers and/or one or more other components. Closing switch 124 (or one or more of the switches of switch 124) may connect or couple fuel cell stack 120 to bulk power grid connector 126.

It will be appreciated that switch 124 (or one or more of the switches of switch 124) may be in the open configuration before controller 128 instructs switch 124 to close in step S404, such that fuel cell stack 120 and bulk power grid connector 126 are decoupled or disconnected before step S404.

It will be appreciated that step S404 may be performed in second phase 174 of energy storage mode 170.

At step S406, the fuel cell stack may generate fuel from the excess power.

Controller 128 may configure fuel cell stack 120 to generate fuel from the excess power in local bulk power grid 106. For example, controller 128 may toggle switch 128 (or one or more switches of switch 128) to couple or connect fuel cell stack 120 and local bulk power grid 106.

Fuel cell 120 may generate fuel for an indeterminate period of time. The length of the fuel generation time may be determined by controller and/or specified by the input condition. Control systems 112 may determine the appropriate fuel generation time, such as based on measurements of the voltage or other characteristics of fuel cell stack 120 and other storage devices, the performance of one or more other components in microgrid 104 and/or local bulk power grid 106, etc.

It will be appreciated that step S406 may be performed in third phase 176 of energy storage mode 170.

Method 400 may include any number of additional steps not described above. As well, method 400 may include fewer steps than those described above. The steps described above in method 400 may also be performed in a different order than that described above and/or may be combined into few steps.

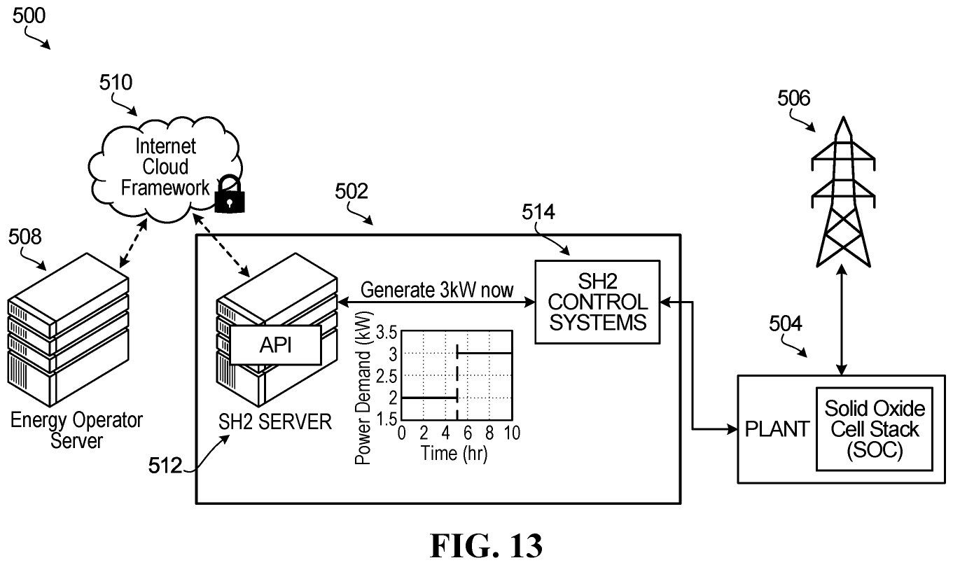

FIG. 13 depicts an example microgrid system 500, according to some embodiments. It will be appreciated that system 500 may include many components of power system 100 discussed above.

System 500 includes a microgrid manager 502, a microgrid 504 and a local bulk power grid 506. It will be appreciated that microgrid manager 502, microgrid 504 and local bulk power grid 506 may be similar or identical to microgrid manager 102, microgrid 104 and local bulk power grid 106, respectively. Microgrid manager 502 may provide instructions (e.g. an input condition) to microgrid 504 and receive information or measurements from microgrid 504 and/or local bulk power grid 506. Microgrid 504 may be connected or coupled to local bulk power grid 506.

System 500 also includes computing device 508, which may be associated with an energy operator. For example, computing device 508 may be an energy operator server, which an energy operator may use to communicate with microgrid manager 502.

Computing device 508 may communicate with microgrid manager 502 over a network 510, which may be the Internet, an intranet, a wired connection, another wireless connection, etc. For example, network 510 may be an internet cloud framework. Computing device 508 may transmit instructions to and receive information from microgrid manager 502 over network 510.

Microgrid manager 502 may include a network interface 512, which may allow microgrid manager 502 to communicate with computing device 508 and/or other computing devices over network 510. Network interface 512 may be a server (e.g. an SH2 server), an API or something other interface, including a physical port.

As noted above, microgrid manager 502 may receive instructions from computing device 508. For example, microgrid manager 502 may receive generation and storage commands, demand requests (e.g. number of KJW-h needed), etc. Microgrid manager 502 may also transmit available capacity information, cost per kW-h information, etc. In some examples, this information may be used by computing device 508 to generate instructions.

Generally, instructions from computing device 508 may include an input condition or an instruction to generate an input condition. Microgrid manager 502 may generate the input condition based on the received instruction.

Microgrid manager 504 may include a control system 514. Control systems 514 may be similar or identical to control systems 112 discussed above. Control systems 514 may be used to generate the input condition based on an instruction from computing device 508 or to implement an input condition. For example, control systems 514 may be used to configure microgrid 504, such as a fuel cell stack, rapid discharge electric storage system, switch or other component in microgrid 504, based on the input condition. Control systems 514 may also monitor microgrid 504 and/or components of microgrid 504 in a closed loop.

It will be appreciated that microgrid manager 502 may be physically located in microgrid 504, or portions or microgrid manager 502 may be physically located in microgrid 504. For example, control system 514 may be hosted on a computing device in microgrid 504, such as a controller in microgrid 504.

In some examples, system 500 may be used for an existing system or grid to adopt sustainable, green and rapid-response metal-supported SOC technology to provide a pathway for hydrogen integration into the power grid. System 500 may enable grid services including supporting intermittent generation and rapid load following in response to grid signals.

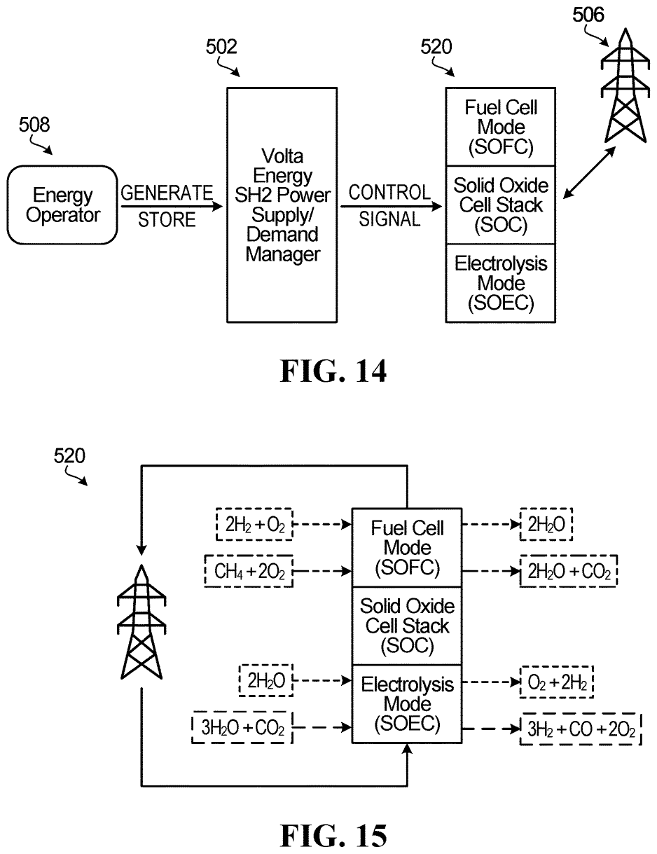

FIG. 14 depicts an example operation of system 500. An energy operator associated with computing device 508 may transmit an instruction to microgrid manager 502. Microgrid manager 502 may relay the instruction in the form of an input condition to microgrid 504, which may include an instruction for an energy buffering mode or an energy storage mode.

Microgrid 504 may include fuel cell stack 520, which may be operable in a fuel cell mode or an electrolysis/electrolyzer mode. Fuel cell stack 520 includes at least one fuel cell and at least one electrolyzer, and in some implementations the electorlyzer may be a reversible fuel cell. A controller in microgrid 504 may configure fuel cell 520 to operate in the fuel cell mode or electrolyzer mode, as described above. Control systems 514 may also guide, instruct or control the operation of the controller.

In some examples, fuel cell stack 520 may be a solid oxide cell (SOC) stack. Fuel cell stack 520 may also be reversible and so may be a ReSOC.

In some implementations, system 500 may include a power supply/demand manager, a device for control signal generation, and a device for control signal communication between the supply/demand manager and the ReSOC stacks, as depicted in FIG. 14.

FIG. 15 depicts an example fuel cell stack 520, according to some implementations. Fuel cell stack 520 may include an SOC stack, as discussed above.

In the fuel cell mode (SOFC), fuel cell stack 520 may generate energy from methane gas (CH₄) as fuel. It will be appreciated that other examples of fuel may be hydrogen or hydrogen-based. The generated energy may be used to power local bulk power grid 506.

In the electrolysis or electrolyzer mode (SOEC), fuel cell stack 520 may generate fuel using power from local bulk power grid 506. The fuel may be syngas or synthesis gas (a mixture of hydrogen and carbon monoxide). Other examples of fuel may be hydrogen or hydrogen-based.

n the fuel cell mode, fuel cell stack 520 may provide a steady sufficient power supply when the load fluctuates frequently, a system output voltage with good robustness, and the ability to catch up with changing power requests within seconds. In the electrolysis mode, fuel cell stack 520 may generate, for example, hydrogen to store excess grid energy for future use. Fuel cell stack 520 may toggle (or be toggled) between the two modes. Fuel cell stack 520 may also maximize economy of the ReSOC operation.

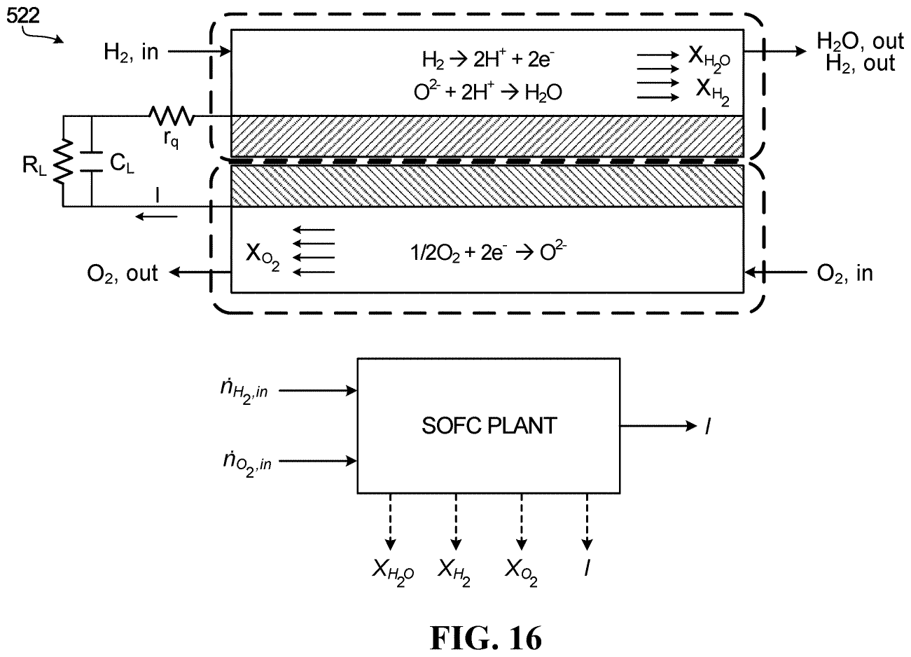

FIG. 16 depicts an SOFC model 522 of fuel cell stack 520 in the fuel cell mode, according to some implementations. SOFC model 522 may be similar or identical to one or more models in microgrid models 142.

SOFC model 522 may electrically model fuel cell stack 520 in the fuel cell mode, as well as the chemical reactions of fuel cell stack 520 in the fuel cell mode.

In addition, SOFC model 522 may model the inlet flow rate of hydrogen and oxygen (\dot{n}_{H2,in} and \dot{n}_{O2,in}, respectively) as input and the current I generated by the fuel cell as an output. The concentrations of water, hydrogen, oxygen (X_{H2O}, X_{H2} and X_{O2}, respectively) and the generated current I may also be monitored to control fuel cell stack 520 in the fuel cell mode in a closed loop.

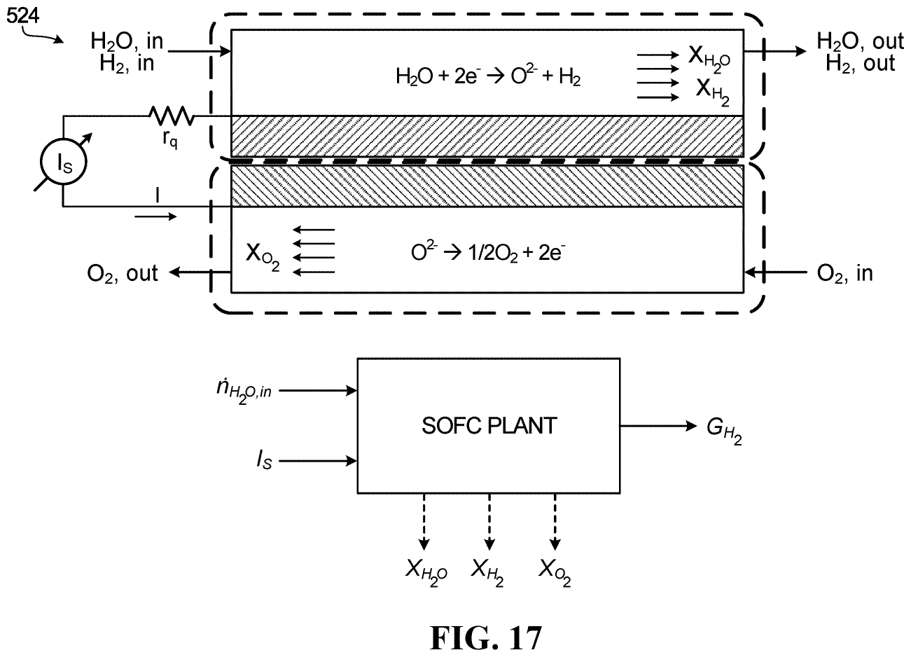

SOFC model 522 may be a plant controlled by one or more of control systems 514.
FIG. 17 depicts an SOEC model 524 of fuel cell stack 520 in the electrolysis or electrolyzer mode, according to some implementations. SOEC model 524 may be similar or identical to one or more models in microgrid models 142.

SOEC model 524 may electrically model fuel cell stack 520 in the electrolyzer mode, as well as the chemical reactions of fuel cell stack 520 in the electrolyzer mode.

In addition, SOEC model 524 may model the inlet flow rate of water (\dot{n}_{H2O,in}) and an applied outsource current (I_{S}) as input and hydrogen (G_{H2}) generated by the fuel cell as output. The concentrations of water, hydrogen and oxygen (X_{H2°}, X_{H2} and X_{O2}, respectively) may also be monitored to control fuel cell stack 520 in the electrolyzer mode in a closed loop.

SOEC model 524 may be a plant controlled by one or more of control systems 514.

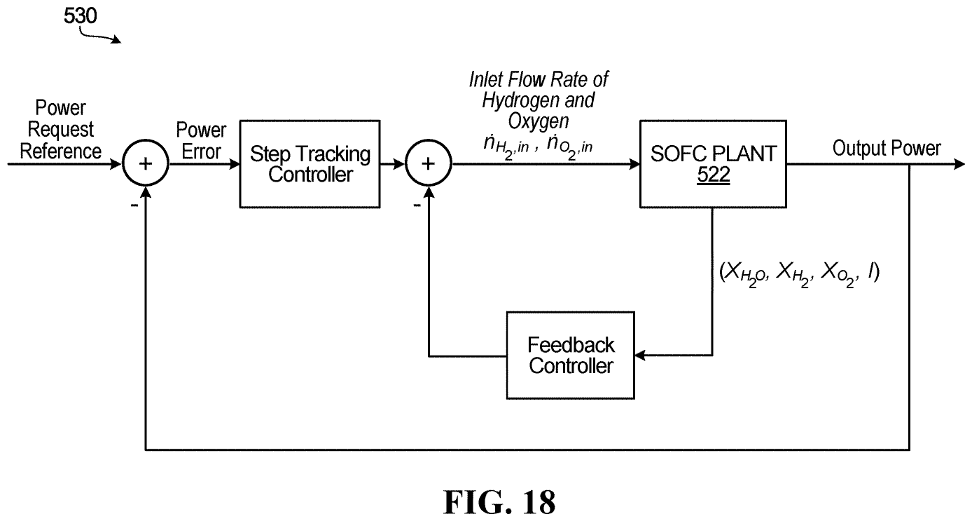

Control systems 514 may include one or more control systems. In some implementations, control systems 514 may include a fuel cell control system 530, which may be used to control fuel cell stack 520. FIG. 18 depicts an example fuel cell control system 530, according to some implementations.

As depicted, fuel cell control system 530 controls the power generated by fuel cell stack 520 in the fuel cell mode. As such, fuel cell control system 530 includes SOFC model 522.

In other implementations of fuel cell control system 530, fuel cell stack 520 may be configured in the electrolyzer mode to generate fuel and fuel cell control system 530 may include SOEC model 524.

It will be appreciated that other implementations of fuel cell control system 530 may also be possible.

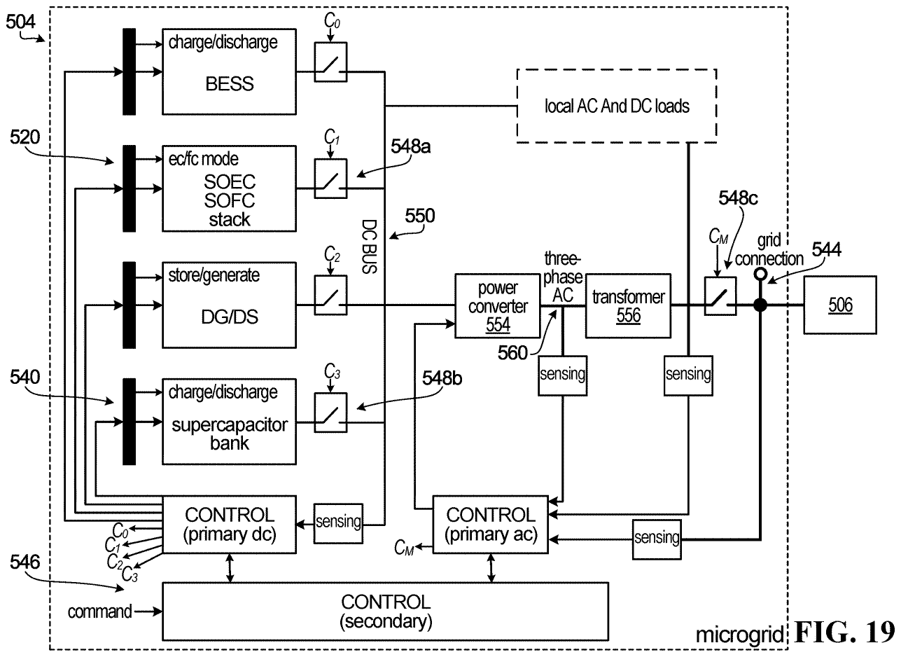

FIG. 19 depicts a block diagram of microgrid 504 connected to local bulk power grid 506, according to some implementations.

Microgrid 504 includes fuel cell stack 520 and a supercapacitor bank 540, which may include one or more supercapacitors. It will be appreciated that supercapacitor bank 540 may be an implementation of rapid discharge electric storage system 122 discussed above. In other implementations, supercapacitor bank 540 may be replaced with a different example of rapid discharge electric storage system 122.

Microgrid 504 also includes a bulk power grid connector 544, which may be similar or identical to bulk power grid connector 126. Bulk power grid connector 544 may be connected to local bulk power grid 506.

Microgrid 504 also includes a controller 546, which may be logically connected to or in communication with fuel cell stack 520, such as over a digital or data bus. Controller 546 may be configured to toggle fuel cell stack 520 between the fuel cell mode and the electrolyzer mode.

Controller 546 may also be logically connected to or in communication with supercapacitor bank 540 and/or bulk power grid connector 544.

Microgrid 504 also includes a plurality of switches, including a first switch 548a, a second switch 548b and a third switch 548c. First switch 548a may be connected or coupled to fuel cell bank 520, second witch 548 b may be connected or coupled to supercapacitor bank 540 and third switch 548c may be connected or coupled to bulk power grid connector 544.

Microgrid 504 may also include other switches. It will be appreciated that first switch 548a, second switch 548b and third switch 548c collectively may be an example of switch 124, which may include one or more switches.

Controller 546 may also be logically connected to or in communication with first switch 548a, second switch 548b and third switch 548c, such as over a digital or data bus. Controller 546 may be configured to toggle first switch 548a, second switch 548b and third switch 548c, individually and collectively, between an opened configuration and a closed configuration.

First switch 548a and second switch 548b may each also be connected to a power bus or DC bus 550. Toggling first switch 548a and second switch between the opened/closed positions, such as by controller 546, may decouple/couple fuel cell stack 520 and supercapacitor bank 540, respectively, from DC bus 550.

Third switch 548c may also be coupled to DC bus 550. Toggling third switch 548c, such as by controller 546, may couple/decouple bulk power grid connector 544 from DC bus 550.

In some implementations, third switch 548c may not be directly connected to DC bus 550. For example, third switch 548c may be connected to a power converter 554, which may convert the DC power from the DC bus 550 to AC power and/or three phase AC power (such as on an AC bus). The AC power may be input into third switch 548c. Third switch 548c may also be connected to a transformer 556 (which may include a plurality of transformers).

Transformer 556 may mediate between microgrid 504 and local bulk power grid 506. Power converter 554 may provide both inversion (DC to AC) and regulation or rectification (AC to DC) for microgrid 506. This may allow microgrid 504 to provide power that is phase-and frequency-compatible with local bulk power grid 506. This may also allow microgrid 504 to convert power from local bulk power grid 506 into DC voltage that can be used to drive electrolyzers or battery charging circuits.

In a particular implementation, third switch 548c may be located at location 560 between power converter 554 and transformer 556. At location 560, third switch 548c may have lower voltage requirements than if it were located between transformer 556 and bulk grid connector 554, as the voltage may be lower in microgrid 504 before transformer 556 steps it up for local bulk power grid 506.

In some further implementations, third switch 548c may be located on DC bus 550, directly connected to power converter 554.

It will be appreciated that third switch 548c may be used to couple/decouple bulk power grid connector 544 and DC bus 550. In situations where third switch 548c is closed and bulk power grid connector 544 and DC bus 550 are coupled, closing first switch 548a may couple fuel cell stack 520 to bulk power grid connector 544. Similarly, in situations where third switch 548c is closed and bulk power grid connector 544 and DC bus 550 are coupled, closing second switch 548b may couple supercapacitor bank 540 to bulk power grid connector 544.

Microgrid 504 may also include fuel storage. Fuel storage may represent hydrogen, methane, syngas or any fuel needed to power fuel cell stack 520 and which can be stored by the electrolyzer. The fuel storage may also be used in subsequent local chemical processing, if needed.

Controller 546 may receive an input condition, such as from microgrid controller 502.

Controller 546 may be configured to set operating conditions of fuel cell stack 520 and/or supercapacitor bank 540 based on input receive from microgrid manager 502. As already noted, microgrid manager 502 may forward input from computing device 508, which may be associated with an energy operator.

In other implementations, the input received by controller 546 may be based on a prediction generated by microgrid manager 502. For example, microgrid manager 502 may include a digital twin (not depicted) similar or identical to digital twin 110. The digital twin may model local bulk power grid 506 and/or microgrid 504. The digital twin may generate a prediction for local bulk power grid 506 and/or microgrid 504, which may be forwarded to controller 546. The prediction may include a prediction of duress or excess power in local bulk power grid 506. Controller 546 may correspondingly set operating conditions of fuel cell stack 520 and supercapacitor bank 540 based on the prediction generated by the digital twin.

Controller 546 may further monitor the performance of fuel cell stack 520 and supercapacitor bank 540 in a closed loop after setting the operating conditions. Controller 546 may monitor the operating conditions using control systems 514.

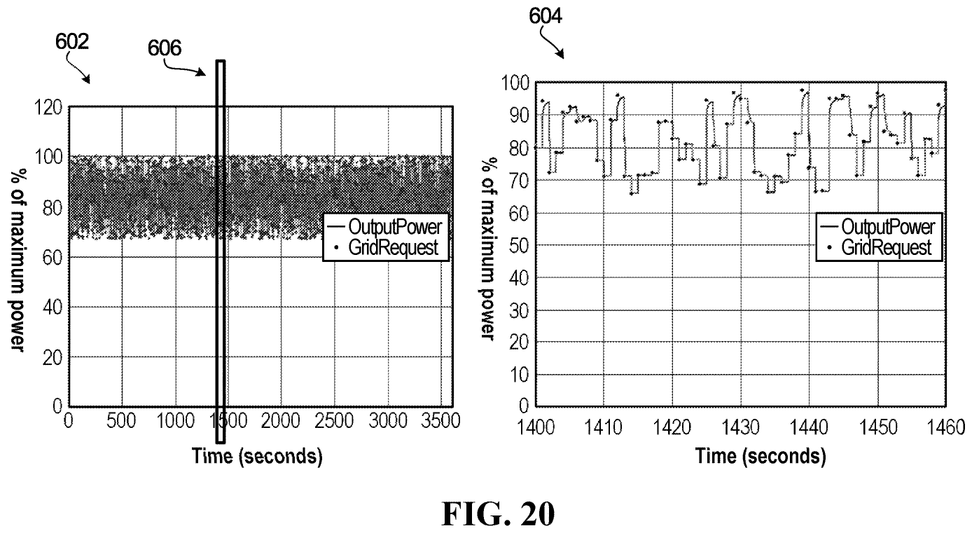

FIG. 20 depicts power plot 602 and zoomed power plot 604, which illustrate some simulated performance improvements which may be achieved using system 100 and/or system 500.

For example, power plot 602 depicts a percent of maximum power handled the microgrid over time, such as microgrid 104 and/or microgrid 504. Zoomed power plot 604 depicts region 606 of power plot 602, which is enlarged or zoomed in for better visibility in zoomed power plot 604.

Zoomed power plot 604 also depicts a percent of maximum power handled the microgrid over time. In particular, zoomed power plot 604 depicts grid requests (dots), which may arrive at the microgrid from a microgrid manager, such as microgrid manager 102 and/or microgrid manager 502. The grid requests may be operating conditions, input conditions and/or other instructions for the microgrid. These grid requests may be automatically generated by the microgrid controller, such as by an AI fault detector, digital twin or control systems. As well, these grid requests may be provided by a computing device associated with an energy operator.

Zoomed power plot 604 also depicts the output power from the microgrid (line). It will be appreciated that the output power from the microgrid tracks the grid requests, such that if an input condition, operating condition or other instruction is received by the microgrid, the microgrid may accurately and quickly respond to the grid request. For example, the microgrid may respond to grid requests in a few seconds or less. The microgrid may have rapid response capabilities and the ability to meet power demands within time constraints.

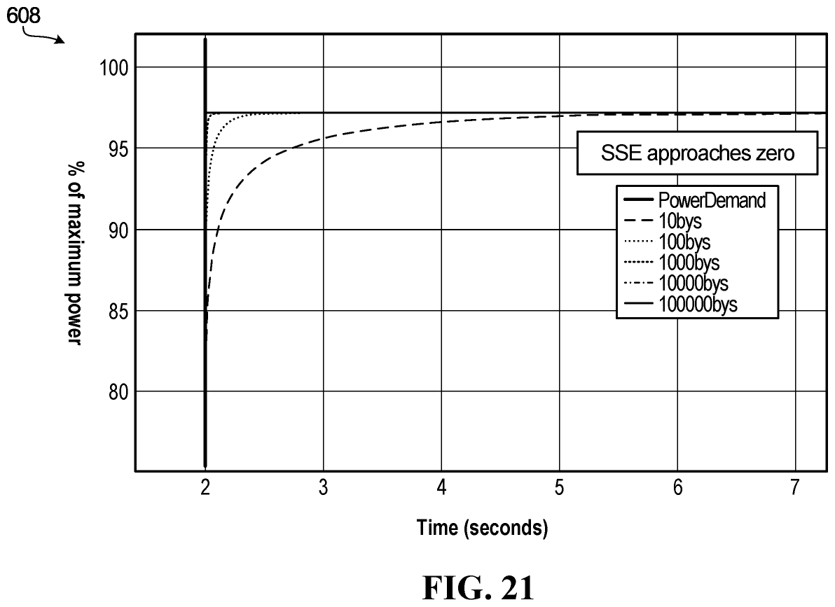

FIG. 21 depicts another power plot 608. As depicted in power plot 608, the microgrid may also be tuneable, such the time for the microgrid to meet a grid request or input condition may be adjusted. For example, the aggressiveness of the microgrid's response may be adjusted. In this way, the microgrid may response to a grid request or input condition no faster than necessary and as slowly as possible to preserve the equipment in the microgrid, such as the fuel cell stacks and/or rapid discharge electric storage system. This tuneability may be accomplished by the control systems in the microgrid manager, which may also consider predictions and approximations generated by the digital twin in the microgrid manager and/or actual measurements of the local bulk power grid and/or microgrid.

For example, reducing the flow rate to the fuel cell stack may reduce the thermal stress on the fuel cell rack. By reducing the flow rate to as little as possible while still responding within a time constraint, the lifespan of the fuel cell stack may be increased. The control systems may also tune and adjust the flow rate depending on the digital twin and/or actual measurements of the local bulk power grid and/or microgrid.

It may be desirable for future power grids to provide reliability, scalability and redundancy. Reliability may mean that the grid ensures a continuous and stable supply of electricity. Scalability may mean the grid can accommodate a variety of energy sources and handle fluctuations in demand. Redundancy may mean that grids are designed with backup systems to prevent outages in case of component failure.

Decentralization may also be desirable, as it may provide resilience and reliability, the ability to integrate renewable energy, improvements in energy efficiency, as well as economic benefits. Environment benefits may also be achieved by decentralization, as well as grid flexibility and demand manager, energy security and scalability.

In overview, the methods and systems described herein may provide a structured architecture and a scalable foundation for a microgrid. For example, the systems may be scalable in terms of power level, from a few kilowatts to gigawatts or more.

The methods and system may make explicit use of mathematical modelling for the (local) bulk power grid and use control theory applied to this system model(s) to determine optimum stabilization and/or regulation.

The methods and systems may also include reversible fuel cell and electrolysis cell technology to gain advantages, such as capital cost minimization and the minimization of cold-start times.

Conventional microgrid control tends to focus on the microgrid itself. As a result, if the broader electrical grid exhibits power quality degradation, existing microgrid solutions will typically island from the grid or attempt to “ride through” fault conditions. Microgrid islanding can be especially detrimental to the power grid as whole and can lead to overall system instability and cascading failure (total loss of electrical power). As more and more microgrids appear in the future, power system stability could be even more fragile. Moreover, the design of controls of a microgrid “in isolation” may not achieve the best performance or resiliency when the microgrid is actually coupled to a real power grid.

However, the methods and systems described herein may provide an overall system which addresses one or more of these problems. The system may provide improved control by accounting for the dynamics of the local bulk power grid (or at least a portion of the local bulk power grid). The system may also account for the dynamical properties of the microgrid itself. Thus, electrical transients and variations in voltage or power may be minimized.

The solutions described herein may also systematize microgrid design. For example, the methods and systems described herein may provide a foundation for microgrids that allows for the integration of DS and (renewable) DG elements, emphasizing overall power system stability and power quality. Microgrids incorporating the methods and systems descripted herein may be equipped with “balanced” or appropriately sized elements given the available DG and load requirements.

As well, solutions discussed herein may also provide fast response times to grid commands, ensuring that the plant (e.g. the fuel cell stack) can quickly adapt to changes in power demand. Simulations have been conducted to demonstrate the ability to track and reach a 1 Hz grid frequency command using the methods and systems described herein, showcasing quick response capabilities.

The solutions described herein may also provide the capability to adjust the response speed to grid commands, allowing for optimized performance while also preserving the lifespan of the reversible SOC. This may be accomplished by reducing local thermal stress and wear during operation. This dual functionality may ensure both efficiency and longevity in the system and its performance.

Other benefits of the systems and methods described herein may also be apparent.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

What is claimed is:

1. A method comprising:
receiving an input condition, wherein the input condition comprises an energy buffering mode or an energy storage mode;
configuring, in response to the input condition comprising the energy buffering mode, a fuel cell stack and a rapid discharge electric storage system to operate in the energy buffering mode, the energy buffering mode comprising:
coupling, for a first time period, the rapid discharge electric storage system to the local bulk power grid, wherein the rapid discharge electric storage system provides a rapid discharge of power to the local bulk power grid; and
coupling, for a second time period, the fuel cell stack to the local bulk power grid, wherein the fuel cell stack operates in a fuel cell mode and provides a steady discharge of power to the local bulk power grid; and
configuring, in response to the input condition comprising the energy storage mode, the fuel cell stack and the rapid discharge electric storage system to operate in the energy storage mode, the energy storage mode comprising:
charging the rapid discharge electric storage system with excess power from the local bulk power grid;
configuring the fuel cell stack to operate in an electrolyzer mode; and
generating, using the fuel cell stack, fuel from the excess power.

2. The method of claim 1, the energy buffering mode further comprising configuring, in the first time period, the fuel cell stack to build current density before discharging power to the local bulk power grid.

3. The method of claim 1, wherein the input condition is based on a prediction generated by a digital twin modelling the local bulk power grid, the prediction comprising at least one of duress or excess power in the local bulk power grid.

4. The method of claim 3, wherein the digital twin further models the rapid discharge electric storage system and the fuel cell stack.

5. The method of claim 3, wherein the digital twin comprises at least one of nonlinear ordinary differential equations (ODEs), machine learning models or deep learning models.

6. The method of claim 1, wherein the fuel cell stack comprises at least one of a Reversible Solid Oxide Cell (ReSOC) or a Proton Exchange Membrane (PEM) fuel cell.

7. The method of claim 1, wherein the fuel generated in the electrolyzer mode by the fuel cell stack is hydrogen or hydrogen-based.

8. The method of claim 1, wherein configuring the fuel cell stack and the rapid discharge electric storage system comprises a controller setting operating conditions of the fuel cell stack and the rapid discharge electric storage system based on the input condition and monitoring performance of the fuel cell stack and the rapid discharge electric storage system in a closed loop.

9. The method of claim 1, further comprising receiving the input condition from a computing device associated with an energy operator.

10. The method of claim 8, further comprising:
detecting, using an artificial intelligence (AI) model, a fault signature in at least one of a measurement or prediction corresponding to the local bulk power grid; and
configuring, using the controller, the operating conditions of the fuel cell stack and the rapid discharge electric storage system based on the detected fault signature.

11. The method of claim 1, wherein the rapid discharge electric storage system comprises at least one supercapacitor.

12. A system:
a fuel cell stack, wherein the fuel cell is operable in a fuel cell mode and an electrolyzer mode;
a rapid discharge electric storage system;
a controller coupled to the fuel cell and the supercapacitor, the controller configured to:
receive an input condition;
configure, in response to the input condition corresponding to an energy buffering mode for a local bulk power grid, the rapid discharge electric storage system to discharge to provide power to the local bulk power grid in a first time period and the fuel cell stack to operate in the fuel cell mode to provide power to the local bulk power grid in a second time period; and
configure, in response to the input condition corresponding to an energy storage mode, the fuel cell stack to perform an electrolyzer function to generate fuel and the rapid discharge electric storage system to charge.

13. The system of claim 12, in response to the input condition corresponding to an energy buffering mode, the controller further configured to configure the fuel cell stack, in the first time period, to build current density before providing power to the local bulk power grid.

14. The system of claim 12, wherein the input condition is based on a prediction generated by a digital twin modelling the local bulk power grid, the prediction comprising at least one of duress or excess power in the local bulk power grid.

15. The system of claim 14, wherein the digital twin further models the rapid discharge electric storage system and the fuel cell stack.

16. The system of claim 14, wherein the digital twin comprises at least one of nonlinear ordinary differential equations (ODEs), machine learning models or deep learning models.

17. The system of claim 12, wherein the fuel cell stack comprises at least one of a Reversible Solid Oxide Cell (ReSOC) or a Proton Exchange Membrane (PEM) fuel cell.

18. The system of claim 12, wherein the fuel generated by the fuel cell stack is hydrogen or hydrogen-based.

19. The system of claim 12, wherein configuring the fuel cell stack and the rapid discharge electric storage system comprises a controller setting operating conditions of the fuel cell stack and the rapid discharge electric storage system based on the input condition and monitoring performance of the fuel cell stack and the rapid discharge electric storage system in a closed loop.

20. The system of claim 12, the controller further configured to receive the input condition from a computing device associated with an energy operator.

21. The system of claim 12, the controller further configured to:
receive, from an artificial intelligence (AI) model, a detection of a fault signature in at least one of a measurement or prediction corresponding to the local bulk power grid; and
configure operating conditions of the fuel cell stack and the rapid discharge electric storage system based on the detected fault signature.

22. The system of claim 12, wherein the rapid discharge electric storage system comprises at least one supercapacitor.

23. A system comprising:
a direct current (DC) bus;
a fuel cell stack connected to the DC bus through a first switch, wherein the fuel cell stack is operable in a fuel cell mode for power generation and an electrolyzer mode for fuel storage;
a supercapacitor bank connected to the DC bus through a second switch;
a third switch coupling the DC bus to a bulk power grid connector;
a controller in communication with the first switch, the second switch, the third switch and the fuel cell stack, the controller configured to:
open and close at least one of the first switch, the second switch or the third switch; and
toggle the fuel cell stack between the fuel cell mode and the electrolyzer mode.

24. The system of claim 23, further comprising one or more transformers coupled to the bulk power grid connector.

25. The system of claim 23, further comprising a power converter for converting DC power from the DC bus to three-phase alternating current (AC) power for input to the third switch.

26. The system of claim 23, the controller further configured to:
set operating conditions of the fuel cell stack and the supercapacitor bank based on at least one of input received from a computing device associated with an energy operator or a prediction generated by a digital twin modelling a local bulk power grid coupled to the bulk power grid connected; and
monitor performance of the fuel cell stack and the supercapacitor bank in a closed loop.

27. The system of claim 26, the prediction generated by the digital twin corresponding to a prediction of duress or excess power in the local bulk power grid.

28. The system of claim 23, wherein the fuel cell stack comprising at least one fuel cell and at least one electrolyzer.
